(19) United States
(12) Patent Application Publication
(10) Pub. No.: US 2025/0271596 A1
(43) Pub. Date: Aug. 28, 2025

(54) METHODS AND SYSTEMS USING A METASURFACE TO ENHANCE RADAR SENSING

(71) Applicants: Mohammad Omid BAGHERI, Waterloo (CA); George SHAKER, Waterloo (CA)

(72) Inventors: Mohammad Omid BAGHERI, Waterloo (CA); George SHAKER, Waterloo (CA)

(21) Appl. No.: 19/059,649

(22) Filed: Feb. 21, 2025

Related U.S. Application Data
(60) Provisional application No. 63/556,524, filed on Feb. 22, 2024.

(51) Int. Cl. G02B 1/00; G01S 13/75

(52) U.S. Cl. CPC G02B 1/002; G01S 13/75

(57) ABSTRACT

The disclosure is directed at methods and systems using a metasurface to enhance radar sensing. The system of the disclosure may be seen as a system that provides high near-field sensing in radar systems for biomedical signal monitoring or sensing applications. In some embodiments, the disclosure is directed at a metasurface that combines low profile and high integration capability to accommodate mm-wave frequencies.

### CROSS-REFERENCE TO OTHER APPLICATIONS

The current disclosure claims priority from U.S. Provisional Application No. 63/556,524 filed Feb. 22, 2024 which is hereby incorporated by reference.

### FIELD

The disclosure is generally directed at radar sensing and, more specifically, is directed at methods and systems using a metasurface to enhance radar sensing.

### BACKGROUND

Radar systems have recently been used in many bio-sensing applications to extract specific bio-signals pertaining to the target individual's health. They can be successfully applied to contactlessly characterize a number of biomedical parameters, detect emergencies, and provide excellent long-term care benefits. Over the last decade, several attempts have been developed that demonstrate the potential of using Al-powered radar systems for non-invasive different applications such as glucose sensing, wearable sweat monitoring, multi-person vital sign tracking, gait monitoring, fall detection, human eye activity monitoring and imaging. Compact radars are also often used in wearable technology, such as smartwatches, for routine human health monitoring.

Radar system development for industrial and biomedical microwave applications has recently accelerated due to an increase in interest in millimetre (mm)-wave communication for near-field sensing using low-profile and low-cost antennas that provide sufficient energy penetration into the target individual's body.

When considering the hardware design of a radar system, the radar chipset architecture and an appropriate design of the accompanying antenna are required. When used in bio-sensing applications, the performance of a radar hardware system is evaluated by utilizing the antenna's near-field sensing capabilities when placed in close proximity to a human body. Near-field-focused (NFF) antenna design for body-centric wireless communications applications has been known for a long time. Utilizing the radiated power of the transmitter antenna by focusing the electric field at a specific location close to the radar surface is an effective method for improving near-field sensing.

Most commonly used radars, which are off-the-shelf and commercially available at an affordable price, can enhance their performance through advancing the antennas or the integration of lenses, eliminating the need for retooling or re-manufacturing. However, despite these enhancements, current designs are still insufficient for biomedical applications.

The challenges associated with radar antenna design for biomedical applications are multifaceted, including frequency selection, physical design complexity, and near-field operation requirements. Different types of antennas, such as high-profile reflectors or aperture antennas are frequently used to provide high sensing in the near-field region. The quadratic phase for near-field focusing on reflector antennas can be obtained by defocusing the feed away from the focal point. Current solutions produced by this method are bulky and unsuitable for low-profile and compact applications.

Planar antennas with a low profile and easy-to-fabricate features present an alternative option. Two facing microstrip patch antennas, TX and RX, operating at 60 GHZ, are employed in describing a near-field sensing system for glucose level monitoring. However, the single microstrip planar antenna essentially provides low field intensity in the near-field region. To address this challenge, a near-field focused microstrip array antenna operating at 2.45 GHz is use to maximize the power transmission efficiency between two antennas. However, a large number of array elements are necessary to achieve high focused power in the near-field region resulting in a high-profile structure with a complex feeding network design, high fabrication cost and one which experiences loss.

Space-fed planar array antennas, such as reflectarrays and transmitarrays, offer an alternative by removing the intricate and expensive feeding networks, resulting in higher efficiency by modifying the phase front of the radiated fields from the feed. Examples illustrating this concept include an optically transparent reflectarray antenna operating at 5.8 GHz and a bi-layer resonant wires transmitarray antenna at 157 MHz, both designed to enhance wireless power transfer in the near field. Moreover, near-field multi-focus reflectarray and transmitarray apertures, illuminated by numerous horn antennas, are designed with a distance of 9.6 λ at 5.8 GHz and 9.3 λ at 28 GHz. A folded transmitarray structure fed by a horn antenna at a spacing of 2.2 λ is proposed to concentrate power in both the near and far field at 2.45 GHz. Since the feed is not in the near-field radiation zone, the feeding blockage has no impact on the radiation of the transmitarrays in comparison to the reflectarrays. In the literature on near-field focusing, existing transmitarray antenna designs do not possess the capacity to seamlessly integrate with a low-profile radar system operating at mm-wave frequencies. This limitation is attributed to their conspicuous high-profile structures, along with their reliance on a bulky feed antenna positioned at a considerable distance from the aperture.

Therefore, there is provided a novel methods and systems using a metasurface to enhance radar sensing.

### SUMMARY

In one aspect of the disclosure, there is provided a system for enhancing biomedical signal sensing including at least one radar module for transmitting electromagnetic waves towards a target of interest and for receiving reflected electromagnetic waves; and at least one metasurface located between the at least one radar module and the target of interest for enhancing at least one of the transmitted electromagnetic waves or the reflected electromagnetic waves.

In another aspect, the at least one metasurface includes a set of unitcells, each of the set of unitcells having a four-sided footprint including a set of electrically conductive end portions adjacent each of the four sides; and an electrically conductive connector portion connected to each of the set of electrically conductive portions. In a further aspect, the set of electrically conductive end portions are metallic end portions. In yet another aspect, the electrically conductive connector portion is a metallic, cross-shaped portion. In yet a further aspect, each of the unitcells includes a dielectric substrate on which the set of electrically conductive end portions and the electrically conductive connector portion are applied.

In another aspect, each of the set of unitcells includes a second set of electrically conductive end portions adjacent each of the four sides printed on an opposite side of the dielectric substrate; and a second electrically conductive connector portion connected to each of the second set of electrically conductive end portions printed on the opposite side of the dielectric substrate. In a further aspect, the set of unitcells are arranged in an N×N array. In yet another aspect, the system includes a processor for processing the received reflected electromagnetic waves.

In yet another aspect, the at least one metasurface includes at least two metasurface layers with frame layers therebetween each adjacent pair of metasurface layers. In a further aspect, each of the metasurface layers includes a set of metallic unitcells, each of the set of unitcells having a four-sided footprint including a set of end slots proximate each of the four sides; a cross-shaped slot portion connected to each of the set of end slots; and a set of corner portion slots located in each corner of the unitcell. In another aspect, the set of unitcells are arranged in an N×N array. In yet a further aspect, a square loop element is formed by adjacent unitcells when in the N×N array. In another aspect, the frame layers include a dielectric material.

In another aspect, the system further includes at least two metasurfaces, the at least two metasurfaces tuned for operation at different frequencies. In an aspect, the at least two metasurfaces are associated with one of the at least one radar modules to form a metasurface-radar module pair to receive reflected electromagnetic waves at the different frequencies. In yet another aspect, the system includes a processor wherein each metasurface-radar module pair is connected to the processor for processing the received reflected electromagnetic waves at the different frequencies. In yet a further aspect, the processor compares or combines the received reflected electromagnetic waves at different frequencies.

### BRIEF DESCRIPTION OF THE DRAWINGS

Some embodiments of the present disclosure are illustrated as an example and are not limited by the figures of the accompanying drawings, in which like references may indicate similar elements and in which:

FIG. 1a is a schematic diagram of a prior art system for biomedical sensing applications;

FIG. 1b is a schematic diagram of a system for biomedical sensing applications in accordance with the disclosure;

FIG. 1c is a schematic diagram of another embodiment of a system for biomedical sensing applications in accordance with the disclosure;

FIG. 2a is a graph showing path gain vs radar range for near field and far-field radiation sensing;

FIG. 2b is a graph showing free-space wave impedance variations in the near field;

FIG. 3a is a schematic diagram showing transferred and received power in a radar system in the presence of a metasurface;

FIG. 3b is a transmission line model analysis for the radar system without a metasurface;

FIG. 3b is a transmission line model analysis for the radar system integrated with a metasurface;

FIG. 4a is a schematic diagram of a unitcell designed for radiation in free space;

FIG. 4b is a schematic diagram of a simulation representing the floquet port for the unitcell of FIG. 4a;

FIG. 4c is a schematic diagram of a unitcell for radiation in a human body skin medium;

FIG. 4d is a schematic diagram of a simulation representing the floquet port for the unitcell of FIG. 4c;

FIG. 5a is a graph showing a reflection coefficients investigation of the metasurface unitcells designed in free-space medium with and without contacting body skin model and designed in skin medium with contacting body skin model;

FIG. 5b is a graph showing imaginary part variations of the wave impedances versus frequency for the skin model and the designed metasurface;

FIGS. 6a to 6f are schematic diagrams showing unitcell phase shift based on the number of the elements in x and y directions based on (a) 3×3 elements (b) 5×5 elements (c) 7×7 elements (d) 9×9 elements; (e) the required phase shift compensation of the 7×7 array when TX radar source is in the offset, and (f) the phase difference between the case when source is placed in offset with the case source is placed at the center of the 7×7 array;

FIGS. 7a to 7d are graphs showing simulated transmission coefficients for the unitcell of FIG. 4c for (a) magnitude and phase analysis for various metallic branches lengths at center frequency, Ds=Ls+Ws/2; (b) magnitude and phase analysis for various incident angles at center frequency; (c) magnitude investigation across different frequencies within the desired bandwidth; (d) phase investigation across different frequencies within the desired bandwidth;

FIG. 8a is a schematic diagram of Infineon BGT60TR13C radar chipset and metasurface array;

FIG. 8b is a schematic diagram showing a radar integrated with a metasurface containing a phantom;

FIG. 8c is a photograph showing another embodiment of a system for biomedical sensing applications;

FIG. 8d is a photograph of measurement equipment setup;

FIGS. 9a to 9d are contour plots;

FIG. 9e is a graph showing an s-parameter analysis;

FIG. 10a is a graph showing human skin permittivity variations and their impact on the transmission coefficient of metasurface unitcells;

FIG. 10b is a graph showing air gap thickness variations between the metasurface and human skin phantom;

FIG. 11a is a graph showing near-field power density measurements with and without metasurfaces;

FIG. 11b is a chart showing measured power reflected;

FIG. 12 is a schematic diagram showing a radar module with dual-band metasurface;

FIG. 13 is a schematic diagram of a dual band metasurface and corresponding unit-cell;

FIG. 14 is a graph showing S-parameter analysis of the system of FIG. 13;

FIGS. 15a and 15b are grids showing phase synthesis at (a) focusing at +20 degrees at 59 GHZ, and (b) focusing at −20 degrees at 61 GHZ;

FIG. 16 is a graph showing S-parameter analysis from Tₓ to Rₓ₂ with and without the dual-band metasurface;

FIGS. 17a and 17 are contour plots showing near-field power density within human skin at a) 59 GHz and b) 61 GHZ;

FIG. 18 is a schematic diagram of a metasurface-enhanced multi-radar near-field system;

FIG. 19a is a photograph of a multi-radar system configuration;

FIG. 19b are a series of graphs showing amplitude and phase for each of the radars of FIG. 19a;

FIG. 20 is a graph showing power measurements for different glucose concentration levels;

FIG. 21 is a schematic diagram of a multi-band metasurface;

FIG. 22 is a graph showing reflection co-efficients of a multi-band metasurface;

FIGS. 23a and 23b are heat maps showing phase shift differences;

FIG. 24a is a schematic diagram of a multi-biosensor radar system;

FIG. 24b is a graph showing power density;

FIG. 25 is a graph showing an SNR analysis for different glucose levels; and

FIG. 26 is a schematic diagram of a radar module.

### DETAILED DESCRIPTION

The disclosure is directed at methods and systems using a metasurface to enhance radar sensing. The system of the disclosure may be seen as a system that provides high near-field sensing in radar systems for biomedical signal monitoring or sensing applications. In some embodiments, the disclosure is directed at a metasurface that combines low profile and high integration capability to accommodate mm-wave frequencies.

In one specific embodiment, the disclosure is directed at a system that includes a mm-wave compact radar system for transmitting and receiving high-frequency electromagnetic waves and a metasurface for enhancing the power or signal of transmitted and/or received electromagnetic waves. In other embodiments, the disclosure may be used for non-invasive monitoring of human medical conditions such as, but not limited to, continuous blood glucose monitoring and/or continuous ECG monitoring. In another embodiment, the radar system includes a single-input multiple-output (SIMO) radar chipset. In another embodiment, the radar system or chipset includes a single transmitting antenna and three receiving antennas on a printed circuit board (PCB).

An improvement of the disclosure over current systems is the inclusion of an engineered superstrate (metasurface) that acts as a buffer between the radar system and the human skin.

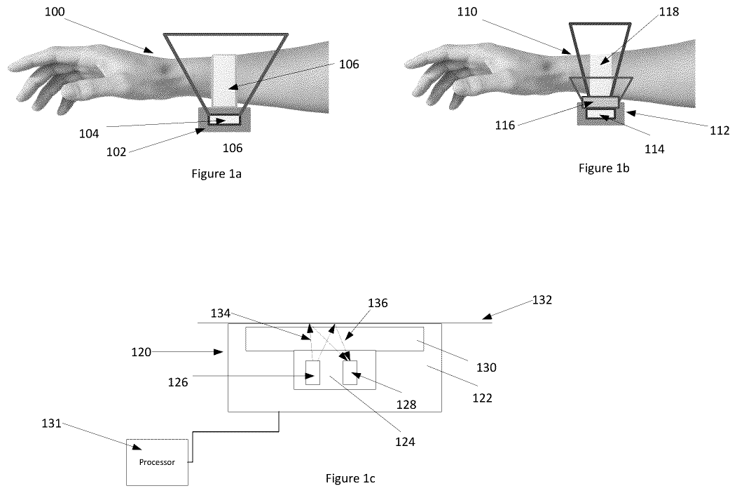

Turning to FIG. 1a, a schematic diagram or a prior art system for biomedical signal monitoring is shown. The embodiment of FIG. 1a may be seen as a smartwatch or a wearable technology system 100 that includes a mechanical housing 102 that houses a radar system 104 that transmits electromagnetic waves towards an individual's body or skin and receives reflected electromagnetic waves. The system 100 further includes a wrist strap 106 that allows the system 100 to be worn on the wrist of the individual.

Turning to FIG. 1b, a schematic diagram of a system for biomedical signal monitoring in accordance with the disclosure is shown. Examples of biomedical sensing applications or systems that the disclosure may be directed at include, but are not limited to, glucose monitoring, skin cancer detection, or heart and/or on-body radar cardiorespiratory monitoring. Similar to the embodiment of FIG. 1a, the system 110 includes a housing 112 that houses a radar system 114 that transmits high-frequency electromagnetic waves and also receives reflected high-frequency electromagnetic waves. Although not shown in detail, in some embodiments, the radar system 114 includes a set of Tx/Rx on-chip antennas. In some specific embodiments, the radar system 114 is an Infineon™-BGT60TR13C radar chipset.

System 110 further includes a metasurface or metasurface structure 116 that is located between the radar system 114 and the individual's wrist or body. The metasurface 116 may include a set or array of unitcells.

A wrist strap 118 enables the radar system 114 (or system 110) to be located proximate the individual's body. In some embodiments, the metasurface 116 enhances near-field energy coupling and signal-to-noise (SNR). As will be understood, the system of FIG. 1b may also be implemented in other types of wearable technology. The presence of the metasurface 116 between the radar system 114 and the individual's body being one of the differences between current solutions and the solution provided by the disclosure.

Turning to FIG. 1c, a further schematic diagram of a system for biomedical signal monitoring in accordance with the disclosure is shown. The system 120 includes a housing 122 for housing a radar system 124 that includes a set of transmitter or transmitter antennas 126 and a set of receivers or receiver antennas 128. In some embodiments, the transmitter 126 and receiver 128 antennas may be combined in the form of a Tx/Rx on-chip antenna. In other embodiments, the number of transmitter antennas 126 may equal the number of receiver antennas 128 but in other embodiments, there may be a different number of transmitter 126 and receiver 128 antennas. In some embodiments, the radar system includes a feed antenna having a set of Tx and Rx antennas with radiation characteristics such as electric field magnitude and phase, and the radiated power density at a specific location in the near field region are extracted using a full wave simulation.

The system 120 further includes a metasurface 130 that is located between the radar system 124 and the skin surface 132 of an individual. In some embodiments, metasurface includes a square layout of an n×n array of unit cells as radiating elements. In one specific embodiment, the square layout may be a 7×7 array of unit cells. In a specific embodiment, and not limiting example, the radiating elements may be formed of two metallic layers printed on both sides of a low-loss dielectric substrate, such as, but not limited to, Rogers-RO4003 material. The radiating elements operate or function to compensate for the different phase delays of the radar antenna radiation and provide the necessary phase shifts for a power-focusing enhancement.

In other embodiments, the planar metasurface is placed at a predetermined distance (such as, but not limited to, about 2.5 mm) above the radar system to provide a compact structure with a near field focused ability leading to near field power enhancement of the signals emitted or transmitted into the human body and higher received power reflected from the human skin. In some specific embodiments, the disclosure includes a two-layer unitcell to make a low-profile array with predetermined dimensions such as, but not limited to, total dimensions of 7.7×7.7 mm².

In other embodiments, the metasurface includes an array of 7×7 unitcells providing a symmetric aperture whereby each unitcell is designed to compensate for spatial phase delays coming from the radar antenna radiation. The phase shift capability of the unitcell depends on some factors such as, but not limited to, substrate thickness, printed metallic shape and number of the layers. The greater number of the layers, the more phase shift changes. However, a compact and low-profile structure is highly required in this application. In one specific embodiment, the disclosure includes a two-layer structure with printed crossed dipole shape that covers the required phase shift of the superstrate aperture with 49 unitcells placed above the antenna with 0.5 λ distance and results in a low-cost structure, low-profile, ease of fabrication and design at the frequency of 60 GHz.

The metasurface enables equal-phase superposition of the propagated fields at the focal point, leading to enhanced power focusing on the near-field (which is the individual's skin). In one embodiment, the disclosure aids in improving impedance matching between free space and the skin, maximizing or improving power into the body, and enhancing the received power level at the receiver antennas.

The system 120 further includes a processor 131 that receives signals representing the received reflected electromagnetic waves and processes these signals accordingly to generate biosensing measurements. In some embodiments, the processor 131 is integrated within the housing 122 and then transmits the measurements to a server for display of the calculated measurements. In other embodiments, the processor 131 is remotely located from the system 120 and receives the signals wireless through known communication methods. In yet further embodiments, the processor 131 may be integrated within the housing to receive the signals and then transmits the signals to another processor for processing of the signals to determine or calculate the biosensing measurements.

Typically, the housing 122 rests against the individual's skin surface 132 and is held in place either via a strap or other known wearable technology mechanisms. In other embodiments where the system is not integrated within wearable technology, the system may be a stand-alone system that is installed or positioned proximate an individual to obtain measurements. The positioning of the system 120 with respect to the individual may be based on the parameters or characteristics of the radar system and the range within which it may function. In other embodiments, the housing 122 may include an opening exposing the metasurface 130 whereby the metasurface is in contact with the human skin when the system is worn or strapped to the body.

In one embodiment, the disclosure includes the subject matter of a matching/focusing layer metasurface between the radar system and the human body. In another embodiment, the disclosure may be an add on component to a radar system. In yet another embodiment, the disclosure may include a radar system that is integrated with a smartwatch or cellphone with the metasurface.

In some embodiments, the disclosure may include a metasurface based on dielectric-only 3D printing technology that reduces the fabrication cost. In yet another embodiment, the disclosure may include a metasurface design to provide higher bandwidth for covering the full operational bandwidth of the Infineon radar antenna. In some embodiments, the disclosure may be integrated or implemented within consumer devices.

In operation, the set of transmitter antennas 126 transmit or emit high-frequency electromagnetic waves 134 towards the individual and then the set of receiver antennas 130 capture of receive reflected high-frequency electromagnetic waves 136. In some embodiments, the radar system 114 or 124 may be a specific mm-wave radar chipset and antenna design that is designed for a specific predetermined body area or body part of interest. For the current disclosure, in biomedical near field sensing, using a planar antenna with a low profile, small size, lightweight, and high field intensity is highly desired as these types of antennas have sufficient energy penetration into the body.

In experiments, the disclosure has been simulated using a full wave electromagnetic simulator and a metasurface was fabricated and measured based on the determined characteristics. The comparison of results between the signals transmitted and received by the antennas of the radar system with and without the metasurface indicates that the presence of the metasurface increased the radiation power around two and a half times without disturbing input matching. This is taught in more detail below.

One advantage of the disclosure is that it addresses the issue of designing a metasurface with good performance to be placed at the near field of the radar system as the radiation of the transmitter antenna at the near field is unpredictable and makes adjusting the phase shift of each unit cell in the array difficult. Another advantage of the disclosure is that it addresses the problem that due to the low distance between the metasurface and the radar system, a high phase shift range at the unitcell is required to compensate for spatial phase delays coming from the antenna radiation. Another advantage of the disclosure is that it addresses the unit cell design problem of reflection from the air-skin interface as a design of a metasurface depends on the surrounding working environment. For example, two different design topologies are required if the metasurface is working on the free-space media or the human body.

In some embodiments, the metasurface 116 of FIG. 1b or the metasurface 130 of FIG. 1c may be seen as a planar transmissive metasurface which acts as a buffer between the antennas of the radar system 114 and the human skin. The planar transmissive metasurface concentrates the near-field power emitted from the transmitting antenna 126 of the radar system 114 into human skin, while simultaneously enhancing the power captured by the receiving antenna of the radar system, thereby improving the overall system sensing capabilities. This may be seen as manipulating the transmitted or reflected high-frequency electromagnetic waves to enhance a resolution and specificity of measurements by focusing electromagnetic energy at targeted depths beneath the human skin. In other embodiments, the metasurface may be positioned such that only the high-frequency electromagnetic waves pass through the metasurface or may be positioned such that only the reflected high-frequency electromagnetic waves pass through the metasurface.

In other embodiments, the system of FIG. 1b or 1c may be seen as a system that includes a near-field-focused metasurface to enhance accuracy of the radar system. In yet other embodiments of the metasurface 116 or 130, the metasurface may provide the advantage of radar sensing enhancement using a single-focus metasurface. For example with respect to a near-field-focused metasurface design for use with a skin medium.

In other embodiments, the system 110 may be seen as a multi-focus bio-sensor system, where data fusion from multiple sensors or systems improves spatial resolution by capturing data from various skin locations at different penetration depths. For a specific application of the system, the radar system 114 is a mm-wave Infineon BGT60TR13C radar chipset with TX/RX on-chip antennas while the metasurface 116 is a skin-focused metasurface. Integrating multi-focus functionalities enables the system to collect data over a broader area and at multiple depths, effectively accommodating physiological variations.

In designing a metasurface 116 or 130 for use in a system for biomedical signal monitoring or sensing, factors including, but not limited to, design of the unit cell for the metasurface and/or analysis of the phase-synthesized array of unit cells may be considered. For clarity sake, it is understood in the following description that use of reference number 116 with respect to the metasurface also refers to metasurface 130.

In one embodiment, as per transmitarray theory, adjusting the phase of the electric field radiation (generated by the high-frequency electromagnetic waves) or adjusting the current sources of the array elements on the antenna's aperture may be performed in order to focus or converge the energy of the electric field and current sources in phase at a specific focal point on the individuals skin (which may be seen as being in the near-field region). When near-field-focused antennas are used in the radar system of the disclosure, the radiated field's maximum or highest level is achieved near the aforementioned focal point. This results in a peak of the power density being positioned between the focal point on the individual's skin and an aperture of the transmitting antenna. In one embodiment, this may be accomplished by using symmetric source-phase tapering, which compensates for the various distances between each source point on the aperture and the focal point. In order to increase the received power (in the form of the reflected high-frequency electromagnetic waves) reflected from the human skin model, impedance matching analysis may be included in the metasurface design.

With respect to radar antenna radiation in the near-field region (or proximate the individual's skin) of the radar system and the unitcell design for the metasurface and phase- corrected array designs for a system that is transmitting high-frequency electromagnetic waves towards human skin, for near field radiation, in order to investigate the radar performance, one can use the Friis radar equation applicable to the near-field region by modifying the parameters for the near-field analysis. These parameters include the antenna gain and radar range. For traditional monostatic radar systems with far-field radiation, the radar path gain is given in equation (1) as:

$$Path Gain = \frac{{P}_{RX}}{{P}_{TX}} = \underbrace{\frac{{G}_{TX}}{4 π {R}^{2}}}_{TX} \underbrace{\frac{{G}_{RX} σ}{4 {( kR )}^{2}}}_{RX} \qquad ( 1 )$$

where P_{TX} and P_{RX} represent the transmitted and received power, G_{TX} and G_{RX} represent the transmitter and receiver antenna gains, respectively, k is the wave number, σ is the radar cross section and R is the radar range between the T_{X} and R_{X} antennas.

According to equation (1), Friis's Law states that as the range increases, the transmitted and reflected power density in the far field diminishes proportionally to the inverse square of the distance as expressed in equation (2) below. However, with respect to the near-field region, electric and magnetic fields behave differently such that this principle needs to be modified as the power decreases at a faster rate than the inverse square. Therefore, the available power in a near-field link is much higher than the usual far-field. Modifying equation (1) using the near-field consideration related to the radar range shows that the received power is proportional to the near electric field as shown in equation (3) below.

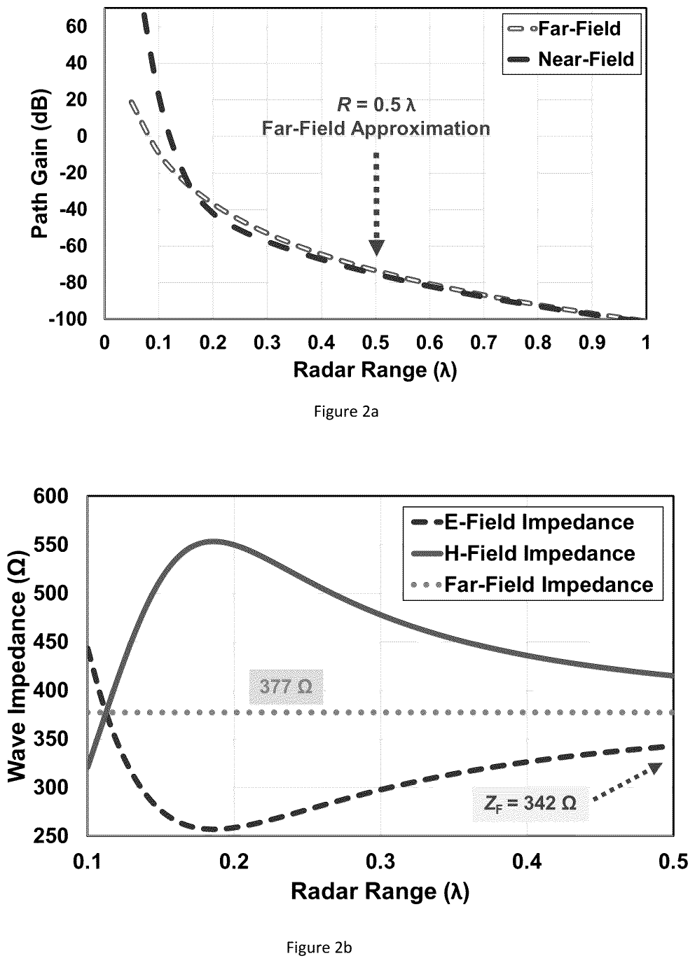

FIG. 2a provides a comparison of path gain variations relative to radar range, contrasting the far-field and near-field scenarios as represented by equations (2) and (3), respectively. As shown in FIG. 2a, at very short ranges, the difference between path gains is in the order of approximately +40 dB. After the range of 0.2 λ, the path gain variations versus the radar range for the near-field, however, is nearly identical to that of the far-field.

$${P}_{RX} \sim {\vert E \vert}^{2} \sim [ \frac{1}{{( kR )}^{2}} ] Far - Field \qquad ( 2 )$$

$${P}_{RX} \sim {\vert E \vert}^{2} \sim [ \frac{1}{{( kR )}^{2}} - \frac{1}{{( kR )}^{4}} + \frac{1}{{( kR )}^{6}} ] Near - Field \qquad ( 3 )$$

$${G}_{TX} , {G}_{RX} = \frac{R e ( \vec{E} \times {\vec{H}}^{*} ) 2 π {R}^{2}}{Input Power} \qquad ( 4 )$$

To achieve a concentrated near-field power, the radar range (seen as the distance between the feeding antenna and the metasurface in contact with or in close proximity to the individual's skin) is a factor to consider. If an airgap distance of λ/2 (λ in free-space) is considered, in accordance with the Fabry-Perot Cavity (FPC) theory, the metasurface 116 is employed in a configuration of a FPC which reduces backscattering and increases the peak radiation of the underlying source antenna enhancing the transferred power density into the skin. As a result, in one example or embodiment, placing the metasurface and the individual's skin at the range of λ/2 at 60 GHZ (about an 2.5 mm air gap above the radar antenna), allows far-field approximation to be used, and utilizing Friis's Law with the transmitted and reflected power variations proportionally to the inverse square of the range use of equation (2) is acceptable.

In the near field region, where the electromagnetic wavefronts are not far enough apart to be considered planar waves, the gain of a radar antenna can be defined in terms of the ratio of the power density in a particular direction with respect to the power density that would be produced by an isotropic radiator at the same distance and with the same input power. Considering the above-mentioned far-field approximation, the relationship between the near-field axial field strength and the near-field gain can be expressed as equation (4). The axial field strength of the antenna in the near field can also be obtained through a full wave simulation. Thus, increasing the electric field intensity in the near-field region of the antenna using the transmissive metasurface 116 has a direct impact on the near-field gain improvement at the specific distance and particular direction for both Tₓ and Rₓ antennas of the radar system.

As a result, according to equation (1), the near-field gain improvement leads to an enhancement or improvement to the received power, P_{RX}, which improves the sensing functionality for the system of the disclosure.

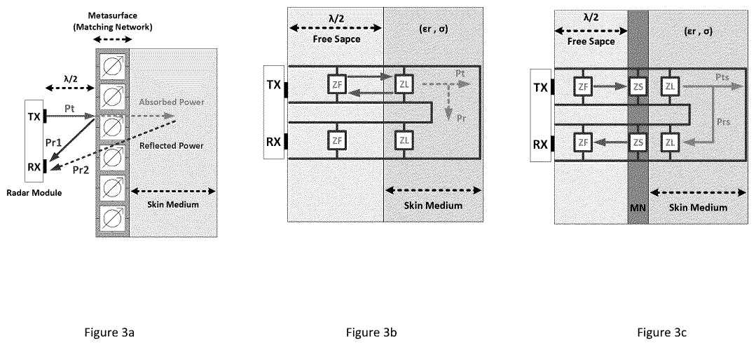

With respect to the metasurface being used as a matching medium, in accordance with the transmitarray theory, using a transmissive metasurface 116 between the radar system and the individual's skin can provide a higher focused transmitted power as well as received power to increase SNR. As the received power (in the form of the reflected electromagnetic waves) received by the Rₓ antenna is a combination of some reflections from the skin medium as well as the metasurface surface, as shown in FIG. 3a as P_{RX}=Pᵣ₁+Pᵣ₂. In this example, the impedance matching considerations are part of the design of the metasurface 116 such that the reflected power from the metasurface, Pᵣ₁, is decreased and P_{RX} mostly provides the information (or level of reflected electromagnetic waves sensed) coming from the individual's skin leading to higher or more accurate biomedical signal sensing.

In the far-field region, the electric and magnetic waves move together with synchronized phases and amplitudes fixed by the impedance of free space, 120 π Ω. However, in the near-field region, these fields are out of phase and the ratio of electric to magnetic field amplitudes is a strong function of both radial distance to the source and orientation leading to wave impedance variations not as equal as 377 Ω. In such a case, the general wave impedance equations can be used for the near-field region as expressed in equation (5) where no is the free-space impedance in the far-field region, β is the propagation constant and R is the distance from the radar antenna surface.

$${Z}_{E} ( r ) = {η}_{0} \times \frac{\vert 1 + \frac{1}{j β R} + \frac{1}{{( j β R )}^{2}} \vert}{\vert 1 + \frac{1}{j β R} \vert} , {Z}_{R} ( r ) = {η}_{0} \times \frac{\vert 1 + \frac{1}{j β R} \vert}{\vert 1 + \frac{1}{j β R} + \frac{1}{{( j β R )}^{2}} \vert} \qquad ( 5 )$$

$${Z}_{L} = \sqrt{\frac{{μ}_{0}}{{ε}_{0} {ε}_{r} ( 1 - \text{?} )}} \qquad ( 6 )$$

$$\text{?} \text{indicates text missing or illegible when filed}$$

In experiments, a half-wavelength distance makes the electric and magnetic field phases diverge and as shown in FIG. 2b, the wave impedance in near-field free-space, Z_{E}=Z_{F}, is obtained as 342 Ω at a predetermined distance which is close to the free-space wave impedance in the far-field region, 377 Ω. In addition, as expressed in equation (6), Z_{L} is defined as the impedance of a general lossy dielectric medium which can be used as the biological load impedance for the skin model.

Given Z_{L} and Z_{F}, the transmission line model is a suitable option to consider impedance matching analysis for design of the metasurface. To achieve this, the human body skin situated in close proximity to the radar antenna is simplified as a homogenous dielectric slab possessing the characteristic properties of the analyzed anatomical skin region at 60 GHz. The impedance of this slab is determined through the utilization of equation (6). The transmission line using the equivalent circuit model for the radar system integrated with and without metasurface is presented in FIGS. 3c and 3b, respectively. In FIG. 3, Pₜ and Pᵣ denote or represent the power that is transmitted through and reflected from the skin medium in the absence of the metasurface. Conversely, Pₜₛ and Pᵣₛ represent analogous power quantities in the presence of the metasurface matching network. Furthermore, Z_{F} is the free-space wave impedance in the near-field region; however, at the point of metasurface interference, λ/2 distance from the antenna surface, the exact value of impedance can be used, or it can be approximated with the free-space wave impedance in the far-field as explained above. In that case, the impedance of the metasurface can be adjusted as Z_{S} by simulating an impinging plane wave upon the transmissive unitcell.

With respect to planar metasurface unitcell design in a skin medium, it is necessary to conduct a design analysis of a periodic unitcell as a transmitting element in order to streamline the design cycle of a transmissive metasurface.

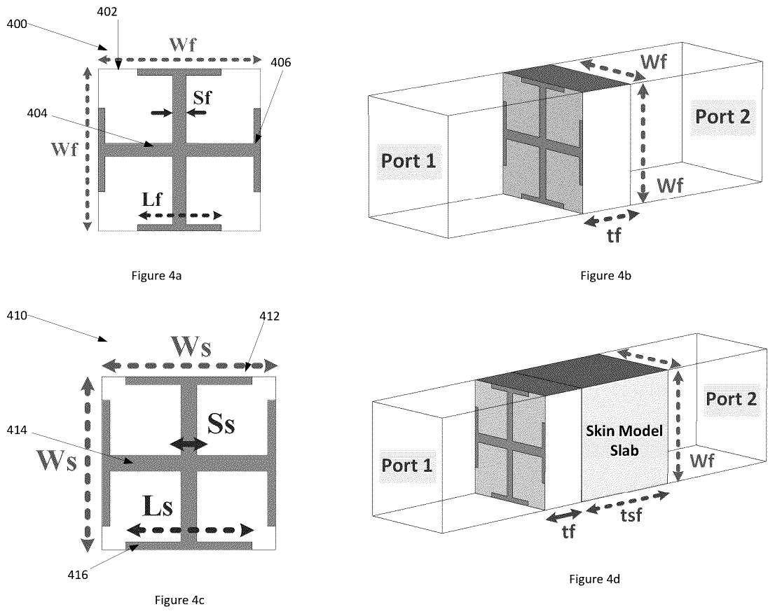

An example unitcell for a transmissive metasurface for radiation in free space is shown in FIG. 4a. The square unitcell 400 has a set of four sides 402 where each side is of length W_{f}. A surface of the unitcell includes an electrically conductive connector structure or portion 404, which in the current embodiment is a somewhat cross-shaped metallic structure, with end portions 406. The end portions 406 are also electrically conductive and may be metallic. A width of the cross-shaped portion 404 is represented by Sf while a length of the end portions is represented by L_{f}. A thickness of the unitcell is represented as t_{f} (as shown in FIG. 4b). In one specific embodiment, the measurements for the unitcell may be W_{f}=2.5 mm, t_{f}=1.25 mm, L_{f}=1.32 mm and S_{f}=0.2 mm. FIG. 4b provides a simulation representing the floquet port analysis for the unitcell of FIG. 4a.

An example unitcell for a transmissive metasurface for radiation in a human skin medium is shown in FIG. 4c. The square unitcell 410 has a set of four sides 412 where each side is of length Wₛ. In some embodiments, the unitcell is a dielectric material with metallic portions applied to the unitcell surface. A surface of the unitcell includes a metallic structure 414, which in the current embodiment is somewhat cross-shaped that is connected with end portions 416. A width of the cross-shaped portion is represented by Ss while a length of the end portions is represented by Lₛ. A thickness of the unitcell is represented as t_{f} (as shown in FIG. 4d). In one specific embodiment, the measurements for the unitcell 410 may be Wₛ=1.1 mm, Lₛ=0.65 mm, Sₛ=0.2 mm, t_{f}=1.25 mm and t_{sf}=3 mm. FIG. 4d provides a simulation representing the floquet port analysis for the unitcell of FIG. 4c in the presences of human skin modelled as a dielectric slab.

As seen in FIG. 4a, the metallic layer is created by a symmetric crossed planar electrical dipole that offers dual-linear polarization, and each branch size can be altered to control the transmitted fields' phases. A full-wave simulator was used to evaluate the unitcell impedance matching at 60 GHz as shown in FIG. 4b using the Floquet port analysis for the infinite array design. In a specific embodiment for use in biomedical applications, FIG. 4d represents the human body skin model which is considered as a dielectric slab with 3 mm thickness and actual features of the body skin based on the fact that the human body skin shows a permittivity of 7.98 and conductivity of 36.4 S/m at 60 GHz, to be contacted with the metasurface unitcell without any air gaps in between.

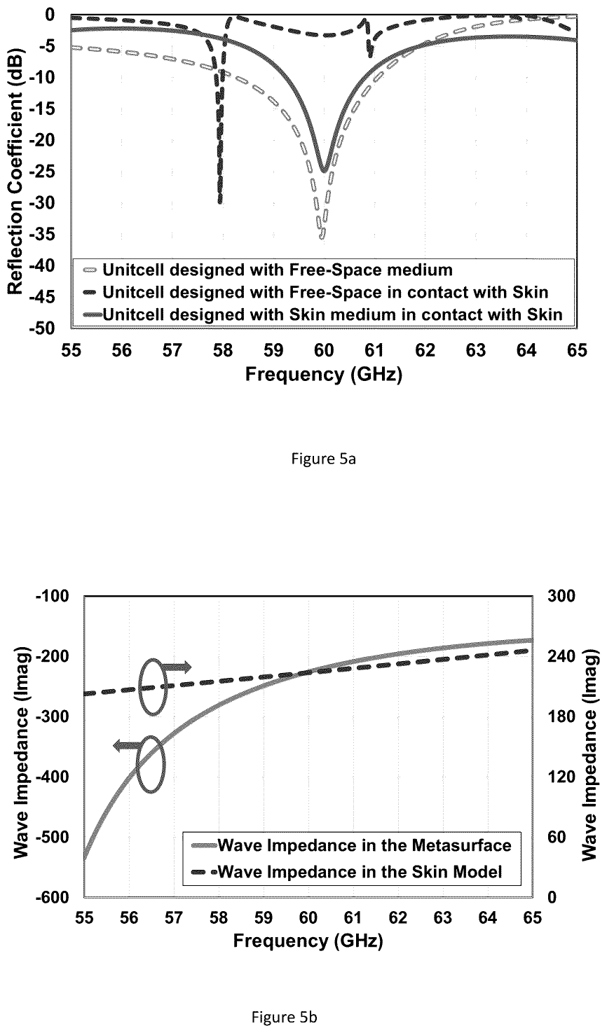

FIG. 5a shows the reflection coefficient analysis of the designed unitcell working in free space versus in human skin medium (respectively shown as FIGS. 4b and 4d). As shown in FIG. 5a, one problem facing the unitcell design is the reflection from the air-skin interface causing a significant mismatching that makes the design process different from the typical metasurface designs reported in the literature.

To have a proper design for increasing the electric field intensity into the body skin, it is necessary to consider the actual model of the skin when designing the unitcell and the related simulation such that the unitcell shows a proper impedance matching while working in contact with the skin, not free space.

In a specific embodiment, according to the microstrip design theory, adding a dielectric slab with ϵᵣ=7.98 instead of ϵᵣ=1 which is used for free-space medium, increases the effective permittivity of the total environment roughly from 2.2 for the unitcell with free-space, to 5.7 for the unitcell with body skin model providing the advantage of the smaller unitcell dimensions leading to low-profile array while reducing phase error losses. In the design of the unitcell working in free-space, FIG. 4a, the typical values of the length and width are considered as 0.5 λ (λ is the free-space wavelength at 60 GHZ) with a 1.25 mm substrate thickness, while the dimensions of the designed unitcell with human body skin model reduce to 0.22 λ with a 0.8 mm substrate thickness (as schematically shown in FIG. 4c). The other advantage of unitcell size reduction is to ensure that W_{F}<λ avoiding more than one spot region appearing in the near-focused region, as a similar concept to the grating lobes occurs in the far-field radiation pattern of any uniformly spaced array.

Turning back to FIG. 4c, FIG. 4c shows a modified version of one embodiment of a metasurface unitcell for use in-body skin radiation. From the reflection coefficient analysis, the unitcell impedance variation in the frequency range of interest is extracted and shown in FIG. 5b which is a graph showing the imaginary part variations of the wave impedances versus frequency for the skin model (or human skin) and the metasurface.

Comparing wave impedances inside the human skin model, Z_{L}, and wave impedance in the metasurface, Z_{S}, indicates that the design parameters of the metasurface are optimized such that providing a capacitive behavior within the desired frequency band and, in particular, a value close to the skin model impedance but opposite in sign at 60 GHz. Therefore, the designed metasurface unitcell is able to counteract the inductive behavior of the human skin model providing high impedance matching at this frequency range as shown in FIG. 5a. As a result, using the designed transmissive metasurface with skin features consideration reveals a high impedance matching at 60 GHz between the radar antenna propagation and the skin model leading to a higher transferred power into the skin medium, Pₜₛ>Pₜ, and higher reflected power received by Rₓ antenna, Pᵣₛ>Pᵣ.

With respect to planar metasurface array design, the metasurface layer is a structure where a wave from a feed is incident on a planar array of elements. In order to produce a desired beam shape on the opposite side of the planar array in a particular location in the near- or far-field region, each element is created to add a particular phase shift to the incident electric field while maintaining magnitude in a level close to the maximum.

Considering a square planar aperture that includes N×N radiating elements, with an inter-element distance Ws along both axes, the (m,n) th element indicates the center point location of each unitcell in the x-y plane, where m and n are integers, varying between (−N+1)/2 and (N−1)/2, N is considered to be an odd number. The electric field radiated at an observation point P(x,y,z) by the N×N array is expressed in equation (7) as,

$$E ( p ) = {\sum }_{m = ( - N + 1 ) / 2}^{( N - 1 ) / 2} {\sum }_{n = ( - N + 1 ) / 2}^{( N - 1 ) / 2} {I}_{mn} {E}_{mn} ( p ) \qquad ( 7 )$$

where Imn and Eₘₙ(p) are the excitation coefficients and the radiated electric field corresponding to the (m,n) th element of the array, respectively. For each element, the feeding-current amplitude is adjusted equal to I₀, while its phase, ϕₘₙ, is selected so that all the element contributions add in phase at the focal point F=(0,0, r₀), located along the normal to the array plane,

$${ϕ}_{mn} = \frac{2 π}{λ} [ \sqrt{( {x}_{m}^{2} + {y}_{m}^{2} + {r}_{0}^{2} )} - {r}_{0} ] + {ϕ}_{0} \qquad ( 8 )$$

where ϕₘₙ-ϕ₀ provides the uniform-phase unitcells in planar array making far-field-focused radiation. When the focal distance, r₀, is greater than the aperture size, the above phase tapering is usually approximated with a quadratic law which is valid for the far-field region. When the observation point is close to the array elements, 2 πR/λ<1, where R is the distance between the radiating element and the observation point, the far-field considerations such as parallel-ray approximation are no longer valid to use in the electric field equation labeled as equation (7). Additionally, the exact phase shift calculation as described in (8) is necessary to focus the electric field at the focal point r₀, which is situated in the near-field region. Approximation formulas result in phase error losses and non-focusing in the near-field.

For some metasurface designs, proper dimensions of the array unitcells may be obtained by finding the required phase delay compensation of the electric field at the frequency of interest using equation (8) in the planar aperture at the metasurface location. This phase compensation mechanism results in an equal-phase superposition of the propagated fields at the focal point in the near-field region.

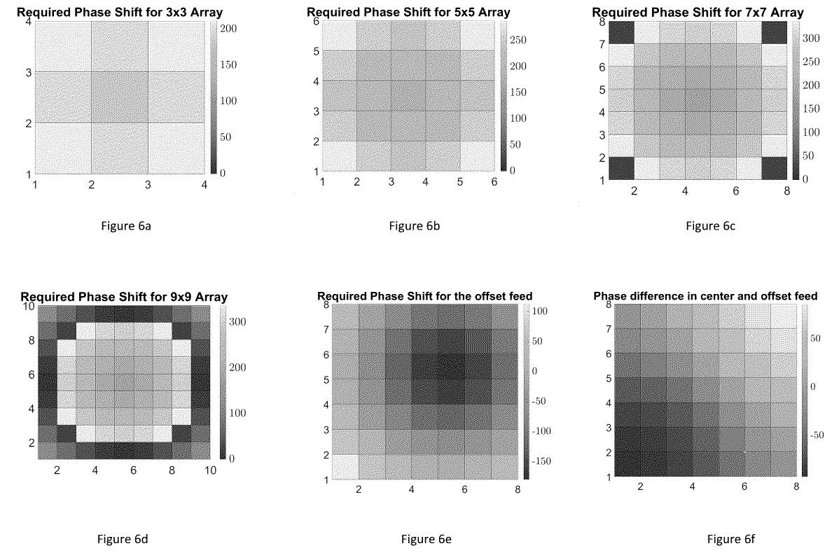

Using equation (8), the required E-field phase compensation ranges on the aperture supposed in the meta-surface location at r₀=2.5 mm are obtained and the accessible phase ranges in x and y directions according to the number of the array elements, from 3×3 to 9×9, are investigated and shown in FIGS. 6a to 6d. More specifically, FIGS. 6a to 6d show a phase shift required for each array is obtained as Δϕ (3×3)=30, Δϕ (5×5)=120, Δϕ (7×7)=210, Δϕ (9×9)=340 degrees which are presented in FIGS. 6a to 6d, respectively. While using more unitcell elements in the metasurface structure increases the electric field intensity, choosing the number of array elements is constrained by the acceptable dimension as determined by the feeding antenna and, above that, the range of the phase range compensation that unitcell can offer.

To design a full planar array metasurface, unitcells that can deliver 360 degrees of phase shift are required to cover the required phase shift range with a minimum or low level at the center element, ϕₘₙ-ϕ₀, and maximum or high level at the edge elements. The maximum or a high phase shift that a single-layer transmitarray metasurface unitcell can provide is 90° for −3 dB transmission coefficient regardless of the shape of the conducting element. To increase the amount of phase shift, stacked multiple single-layer unit cells can be used for the −3 dB transmission bandwidth, the two-layer structure provides a phase shift of up to 180°, whereas the three-layer structure provides a phase shift of up to 300°. Increasing the number of layers also increases the bandwidth for the desired frequency band, while increasing design complexity and manufacturing cost.

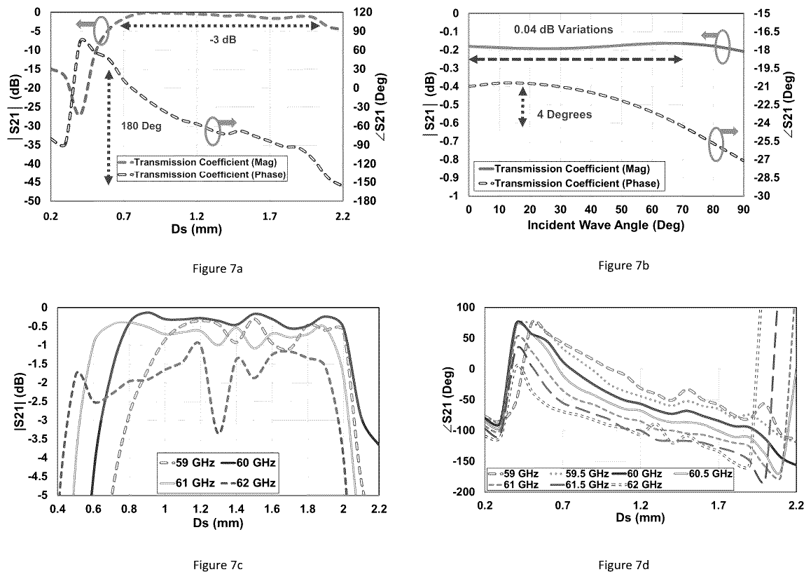

As such, in one specific embodiment, the unitcell may provide up to 180° phase shift at the magnitude reduction of up to −3 dB due to using two metallic layer structures. By changing the length of the metallic crossed dipoles' branches, Dₛ=Lₛ+Wₛ/2, it is demonstrated that the unitcell can provide the desired phase shift range at 60 GHz as shown in FIG. 7a which is a graph showing magnitude and phase analysis for various metallic branches lengths at center frequency, Dₛ=Lₛ+Wₛ/2 for simulated transmission coefficients of the two-layered crossed-dipole unitcell of FIG. 4c in the presence of skin or a skin layer.

Considering FIG. 6, based on the 180° phase shift range that the unitcell provides, a suitable number of the array elements should be selected by including the largest possible aperture to cover the source antenna properly and provide the highest accessible focused power without substantially increasing the phase error loss. FIGS. 6a and 6b show that the 3×3 and 5×5 array elements with required phase compensation of 30° and 120° are not quite effective in a focusing process. Moreover, the 9×9 array with required Δϕ=340° shown in FIG. 6d, makes a large phase error loss due to unitcell phase limitations. Among all options investigated, the array of 7×7 with Δϕ=210° is the closest one to the available 180° phase shift as shown in FIG. 6c. Therefore, the 7×7 array utilizing 49 phase-corrected elements provides the highest power density into the human skin, however it is understood that the other embodiments may also be considered when other power densities are suitable.

In experiments to test embodiments of a metasurface, near-field analysis of the radar system integrated with and without metasurface was performed. In some biomedical application embodiments, the system of the disclosure may be compact with a low-profile radar system or structure. For these applications, the system may include a planar array that includes a source and a transmissive surface or metasurface.

According to transmitarray theory, considering a microstrip PCB antenna as the transmitting source, its near-field performance can be improved in the presence of the human body by adding a surface (such as a metasurface) acting as an impedance-matching network between the source and the human skin. This may be applicable to any type of radar system utilizing planar Tₓ/Rₓ antennas-on-chip.

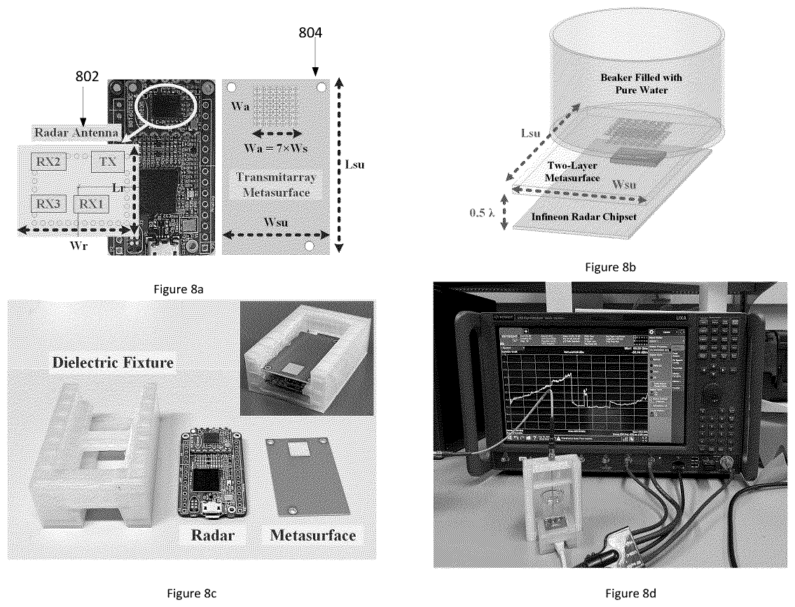

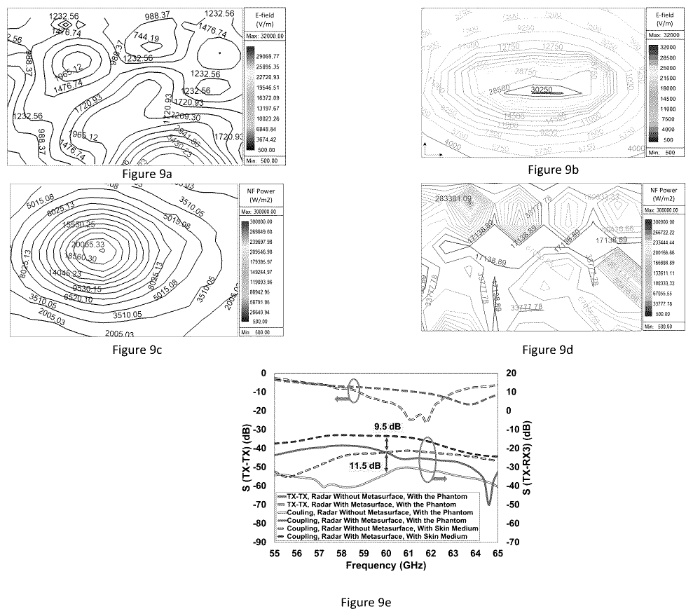

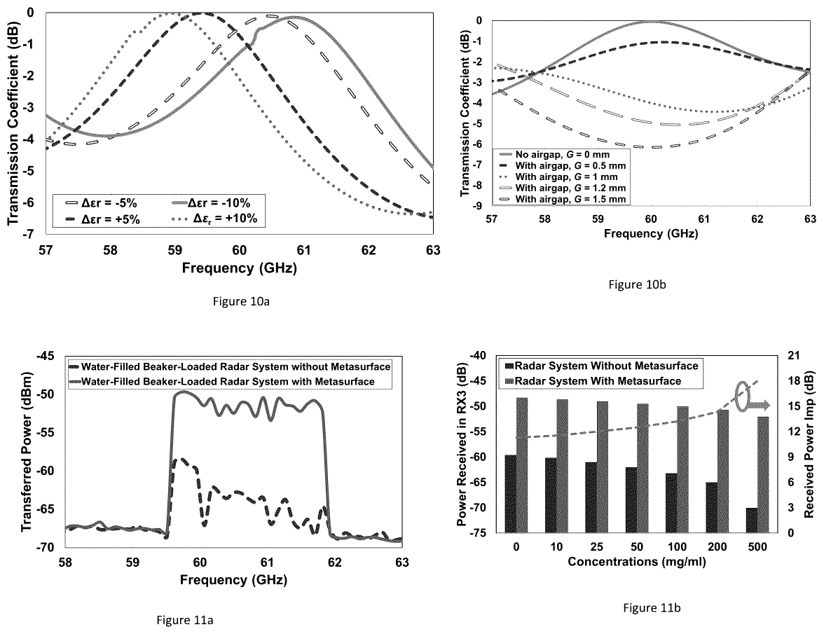

As shown in FIG. 8a, which is a schematic diagram of a radar system and metasurface combination, in one specific embodiment, the radar system 802 is the Infineon BGT60TR13C radar chipset that includes four on-chip antennas, one of which radiates as a transmitter and the others of which function as receivers. The Tₓ antenna can be considered as a feed of the transmitarray, with the planar metasurface 804 located above the radar (such as between the radar system and the human skin or body) is used as a transmitting surface.

In experiments, use of the planar transmissive metasurface 804 with the Infineon BGT60TR13C radar chip antenna or system 802 was performed to determine how the radar system interacts with and without the metasurface regarding free-space and skin impedance matching, near-field focused power absorbed from the transmitter antenna into the human skin, and radar SNR improvement.

In one embodiment, the transmissive metasurface 802 included a 7×7 phase-compensated array of radiating elements with an inter-element distance, Wₛ, along both axes as shown in FIG. 8b integrated with the radar system. For the experiment, the metasurface was placed in contact with a phantom (which was a beaker filled with water in place of human skin).

According to the Fabry-Perot theory, the distance between the radar system and the designed transmissive metasurface was adjusted to maximize or increase the radiated field, as equal as λ/2 at 60 GHz. In order to make the work more feasible and practical in the manufacturing and measurement process, the human body skin was modelled as a phantom considering two interleaved cylindrical dielectric slabs. The phantom included a beaker made by Pyrex glass (ϵᵣ=4.7 and σ=0.5 S/m at 60 GHZ) filled by pure water (ϵᵣ=11.17 and σ=36.4 S/m at 60 GHZ) with 5 mm height contacting the metasurface without air gap. It can be shown that the effective characteristics of the new dielectric medium (combination of the Pyrex beaker and pure water) is sufficiently close to the human body skin at 60 GHZ. In this specific embodiment, some of the parameters of the metasurface shown in FIG. 8b are fixed and selected by the dimensions of the Infineon radar chipset (W_{SU}=26 mm, L_{SU}=40 mm, Wᵣ=6.5 mm and Lᵣ=5 mm.

According to the phase analysis discussed above, the microstrip crossed electric dipoles as transmitting elements are designed for the compensation of the differential spatial phase delays from the radar antenna radiation. In one design embodiment of the metasurface, two assumptions have been considered: i) the source antenna (or transmitter antenna of the radar system) should be placed at the center location of the metasurface so that covering the antenna symmetrically; as a consequence, when the metasurface is integrated with the radar system, the Tₓ antenna has an offset from the center of the array causing phase difference between the elements. The required phase shift compensation when the source is offset and how it differs from the case where the source is positioned in the center are investigated as shown in FIGS. 6e and 6f which are maps showing a required phase shift compensation of the 7×7 array when the Tₓ radar source or antenna is in the offset and a phase difference between when the radar source is placed in offset and when the radar source is placed at the center of the 7×7 array, respectively.

As seen in FIG. 6f, when the Tₓ radar antenna or source is excited, the maximum phase difference of 50° caused by the edge elements affects the array required phase shift leading to phase error loss and E-filed focused deviation. As determined in experiments, this phase error loss causes degradation of 1.2 dB in the maximum accessible focused power density inside the human skin model. Moreover, the offset TX source makes the focused power inside the skin deviate from the orthogonal direction which is not a concern in this application. The radar antenna radiation illuminates the metasurface unitcells in the normal and oblique directions according to its alignment with the array. In such a case, the phase analysis presented in FIGS. 6 and 7a are based on the normal incident considerations. Nevertheless, the phase shift delays of the normal incident wave illuminated the unitcell is different from the oblique incident one. Although using a symmetric metasurface increases the near-field power radiated from the Tₓ antenna and the received power to the Rₓ antenna; the phase error caused by oblique incident radiation from the feed can prevent or reduce the likelikhood of reaching the maximum or a high power improvement as can be obtained for a microstrip patch antenna placed at the center of the array.

The variations of the unitcell transmission coefficients, phase and magnitude, versus incident wave angle, are also investigated and shown in FIG. 7b which is a graph showing magnitude and phase analysis for various incident angles at center frequency for simulated transmission coefficients of the two-layered crossed-dipole unitcell of FIG. 4c in the presence of skin or a skin layer.

As shown, taking advantage of the low-profile unitcell, when the unitcells are illuminated at various locations, the oblique incidents have a very low impact on the magnitude and phase of the unitcell. As shown in FIG. 7b, for a metasurface placed at λ/2 distance, the maximum or high incidence angles up to 70° required at the edge elements causes the phase deviation lower than 3°, while the magnitude makes only 0.04 dB variations. Therefore, the phase error loss caused by the oblique incident is negligible, which simplifies the design process while guaranteeing nondestructive effects on the phase difference compensation.

The above experiments were performed with a metasurface unit cell and array, with the analysis conducted at the central frequency of 60 GHZ. In light of the designated bandwidth from the source antenna, the Infineon radar chipset spanning 58 to 63 GHZ, it becomes important to assess the fluctuations in transmission coefficients across the entire frequency spectrum within the specified range. It is understood that the disclosure may also operate with radar systems that transmit mm-waves. This comprehensive evaluation is essential for ascertaining the overall bandwidth of the entire system. FIG. 7 illustrates the magnitude and phase responses of the two layers' unit cell for varying lengths of crossed dipole metallic branches. The results are presented across different frequencies within the bandwidth of interest. In FIG. 7c (which is a graph showing magnitude investigation across different frequencies within the desired bandwidth for simulated transmission coefficients of the two-layered crossed-dipole unitcell of FIG. 4c in the presence of skin or a skin layer), it can be seen that that the frequency range from 59 GHz to 61 GHz exhibits a favorable transmission magnitude change, with a maximum or a high reduction of 1 dB. Conversely, at 62 GHZ, a higher reduction exceeding 3 dB is observed, indicating that the power improvement technique is less effective at this frequency. However, merely examining the transmission coefficient's magnitude is insufficient for determining the bandwidth of the metasurface-enhanced radar design. Consequently, the transmission coefficient's phase, as depicted in FIG. 7d (which is a graph showing magnitude investigation across different frequencies within the desired bandwidth for simulated transmission coefficients of the two-layered crossed-dipole unitcell of FIG. 4c in the presence of skin or a skin layer) within the desired bandwidth was investigated. Notably, the phase response for frequencies ranging from 59.5 to 61.5 GHz appears nearly parallel, providing a constant shift throughout the bandwidth. Given the satisfactory results obtained from both magnitude and phase analyses of the transmission coefficient in the frequency range of 59.5 to 61.5 GHZ, it is anticipated that the near-field-focused radar antenna integrated with the designed metasurface, affords a 2 GHz bandwidth to enhance near-field power within the skin.

For testing, the metasurface structure was simulated using a full wave electromagnetic simulator and the results of near electric field magnitude and focused power density of the radar system in the presence or absence of the metasurface were obtained inside the pure water modelled as a cylindrical slab. For this model, the maximum or a high peak of the power density occurs at a 2 mm distance above the metasurface, 1 mm above the beaker bottom, inside the pure water model. As shown in FIGS. 9a and 9b, which are simulated 2D contour plots of the radar system for the Tx antenna near-field radiation inside the beaker-filled with pure water, at 60 GHz at 1 mm above the beaker bottom, 2 mm above the metasurface, illustrating radiated electric field intensity of radar system without metasurface (FIG. 9a) and radiated electric field intensity of radar system integrated with the metasurface (FIG. 7b), it can be seen that the presence of the metasurface provides a significant enhancement on the near electric field inside the water which is 8.8 times higher than the radar antenna without metasurface. It is expected that the near-electric-field enhancement provides a very directive near-field power density with high intensity.

Turning to FIGS. 9c and 9d, which are 2D contour plots of the power density radiated by the Tₓ radar antenna in the presence and absence of the near-field-focused planar metasurface in a rectangular region, lying on the plane in parallel to the array with 2 mm distance, it can be seen that using the near-field-focused metasurface provides 11.5 dB (more than about 14 times) improvement in the radiated power density across a z-constant surface above the metasurface inside the beaker-filled with pure water model at 60 GHz.

The S-parameter analysis of the simulated reflection and transmission coefficients, S(T_{X}-T_{X}) and S(T_{X}-R_{X3}), for the radar system with and without metasurface, were also investigated, and the comparison results are shown in FIG. 9e. The investigation of the reflection coefficient at the radar Tₓ port shows that using a proper design of the unitcell in contact with the skin model makes an array which is high impedance matched with the beaker-filled with water medium at the frequency bandwidth of 59 to 63 GHZ. FIG. 9e shows that considering the model of the beaker filled with pure water provides 11.5 dB power reflected enhancement from the water medium to one of the radar receivers, R_{X3}, leading to significant enhancement of the radar SNR.

With respect to sensitivity analysis in near-field-focused bio-sensing design, sensitivity analysis may be performed to improve or optimize the near-field metasurface-enhanced radar for biomedical applications. By discerning pivotal parameters shaping device performance, one can precisely refine the design to attain desired sensitivity and accuracy levels. This process enhances the device's robustness, ensuring consistent functionality across diverse conditions, including varied testing scenarios. Furthermore, sensitivity analysis facilitates precise customization, adapting the radar to meet specific biomedical application requirements.

The first analysis involves an exploration into the critical dynamics of permittivity across inter-individual differences in human skin. The electrical characteristics of human tissues, particularly permittivity and conductivity, demonstrate considerable variability among individuals. The intricate interplay of factors, including hydration levels, age, health status, and tissue composition, adds complexity to the characterization of electrical properties. Permittivity, shaped by tissue composition and structure, tends to exhibit more pronounced variations. In contrast, conductivity, influenced by factors like ion concentration and moisture content, generally shows less noticeable fluctuations.

Given the direct contact of the metasurface with the skin in certain embodiments, accurate consideration of the permittivity and conductivity values of the skin is crucial. In biosensing applications that involve skin, fat, muscle, and bone, high inter-individual differences are common due to variations in body shape. However, for specific applications like glucose monitoring or skin cancer detection, where the 60 GHz signal is rapidly attenuated into the body within a few millimeters, individual variations in skin dielectric properties are not substantially impactful. Therefore, it is beneficial to understand how a tolerance of about 10% in permittivity variations influences the metasurface's performance.

Modifying skin permittivity influences the central frequency and the transmission coefficient within the metasurface unitcell analysis. As illustrated in FIG. 10a (which is a graph showing human skin permittivity variations and their impact on the transmission coefficient of metasurface unitcells), at the operational frequency of 60 GHZ, a deviation of ±5% in typical human skin permittivity causes a transmission coefficient reduction of less than 1 dB, while a deviation of ±10% results in reductions of 2 dB and 1.2 dB, respectively. Extending the evaluation to the array structure, it can be shown that altering permittivity by ±5% leads to transferred power reductions of 1.4 dB and 0.9 dB whereby modifying the permittivity by ±10% results in changes leading to power reductions of 2.3 dB and 1.9 dB.

Conducting a comparative analysis between the phantom (beaker of water) and human skin is beneficial to understand how well the phantom mimics the dielectric properties of human skin. The analysis enables the identification of any discrepancies or limitations in the phantom, allowing for refinement and improvement.

The difference between the power reflected from the human skin slab and the proposed phantom, beaker filled with pure water, is investigated and results shown in FIG. 9e. As shown, the metasurface in the presence of the skin model provides 9.5 dB enhancement in the reflected power, whereas the enhancement was 11.5 dB when the beaker was filled with pure water. The difference in the material effective permittivity, ϵ, as well as the conductivity, σ, between the human skin model and the beaker filled with pure water accounts for this 2 dB difference in S(T_{X}-R_{X3}) values. The permittivity and conductivity of pure water at the frequency of 60 GHZ, under typical room temperature conditions, are 11.17 and 65.3 S/m, respectively. Consequently, it is important to consider the impact of the external shell in the calculations. According to the literature, Pyrex glass demonstrates a relative permittivity of 4.7 and a conductivity of 0.5 S/m, at 60 GHz. In such situations, one can compute the effective dielectric properties of composite materials arranged in series across the entire volume facing the metasurface.

The effective permittivity of the overall medium, a beaker filled with pure water, is determined to be 8.75. Consequently, comparing the permittivity of the phantom, 8.75, to that of a typical human skin model, 7.98, at 60 GHz reveals a difference of approximately 0.77. When comparing the permittivity of the phantom with that of human skin, it is noted that the tolerance is within +10%. Consequently, as shown in FIG. 10a, the anticipated outcome is a 2 dB reduction in the power transferred into the phantom compared to the power transferred into human skin. In this scenario, it can be inferred that the difference in focused power has been transformed into dissipated and reflected power, contributing to an enhancement in the reflection power when using the phantom as opposed to the human skin slab. On the conductivity front, the calculated conductivity of the phantom (a beaker filled with pure water), at 60 GHz and room temperature stands at 42 S/m. In contrast, the conductivity of human skin at 60 GHz is measured at 36.4 S/m. This implies that the phantom medium serves as a marginally better conductor, resulting in increased power reflection directed towards the radar.

Therefore, the examination of both permittivity and conductivity indicates that utilizing the phantom, a beaker filled with pure water, results in less transferred power into the medium compared to the human skin medium, leading to an enhancement in power reflection. This is evident in FIG. 9e, where the power reflection from the phantom (11.5 dB) is 2 dB higher than the power reflection from the skin medium (9.5 dB).

In the last phase of sensitivity analyses, the impact of human skin non-uniformity on planar transmissive metasurface performance is investigated. The metasurface of the disclosure is designed as a planar interface to be used with a rigid structure; however, the human body deviates from complete planarity, introducing the possibility of an air gap between the metasurface and the skin. This metasurface-enhanced radar near-field sensing method and system of the disclosure exhibits versatility across biomedical applications, including glucose monitoring, skin cancer detection, and on-body radar cardiorespiratory monitoring.

For a more specific application, in the context of utilizing metasurface-enhanced radar for wrist-worn wearable devices, the effective area of the skin is treated as planar, assuming minimal or no gap between the metasurface and the body. This is supported by the small effective area of the metasurface (for example 7.7×7.7 mm²) and the secure fit of devices like smartwatches, ensuring practical biomedical sensing and achieving high measurement accuracy. However, it is beneficial to explore the performance of the metasurface under conditions where a significant gap exists between the metasurface and the human skin, particularly relevant in other biomedical contexts such as cancer detection. This consideration arises from the fact that in certain applications, there may be a notable separation between the designed metasurface and the human body, warranting an analysis of the impact on the metasurface performance under such conditions.

The simulation analysis encompasses the transmission coefficient of the metasurface unit cell and the transmitted power enhancement of the array structure, considering varying air gap thicknesses from 0 to 1.5 mm. FIG. 10b is a graph showing results from an investigation of air gap thickness variations between the metasurface and human skin phantom. The findings reveal that a 0.5 mm air gap induces a 1 dB reduction in the transmission coupling factor crucial for effective power transfer. The introduction of a 1 mm air gap causes a notable impedance mismatch, resulting in a 4 dB reduction in transmitted power due to the air acting as an additional load. Successive increases in the air gap led to further reductions in the transmitted power and an increase in the power reflected from the air-skin interface. Extending the investigation to analyze transmitted power enhancement using the metasurface within the skin medium, while considering air gap distances of 0.5, 1, and 1.5 mm, a decrease in near-field power enhancement inside the skin of 1.2, 4.5, and 7.5 dB, respectively was observed. It is noted that the designated near-field focal point, positioned 2 mm above the metasurface, does not penetrate the skin medium in the presence of an air gap measuring 2 mm or more. Consequently, this non-penetration leads to a lack of observed power enhancement. Under these conditions, the outcomes align with those observed when the metasurface is not integrated or part of a biosensing sensing system.

In scenarios where uniformity is beneficial for deploying a metasurface-enhanced radar system in various biomedical applications, the impact of non-uniformity can be mitigated. Firstly, reducing the metasurface array size while preserving resolution enhancement capability addresses non-uniformity concerns by maintaining consistent results in a smaller area. Secondly, incorporating a flexible substrate in the metasurface design allows it to conform to body skin contours, effectively minimizing or reducing non-uniformity issues. Thirdly, employing machine learning algorithms, coupled with signal filtering techniques, robustly accounts for skin variability in radar power reception, mitigating interference. Lastly, creating a wideband metasurface enables the radar system to operate across frequencies, offering advantages in penetrating the skin at different depths and interacting distinctively with skin features, potentially providing a more comprehensive perspective.

With respect to near-field transmitted power density and radar SNR measurement, in the fabrication process detailed below, a prototype of a transmitarray metasurface, as depicted in the photograph of FIG. 8c was designed that shows its integration with a radar module or system. This integration was achieved using a 3D printed dielectric fixture, that stabilized the metasurface at a half-wavelength air gap distance above the radar system. In the following, the two sets of measurement processes are discussed.

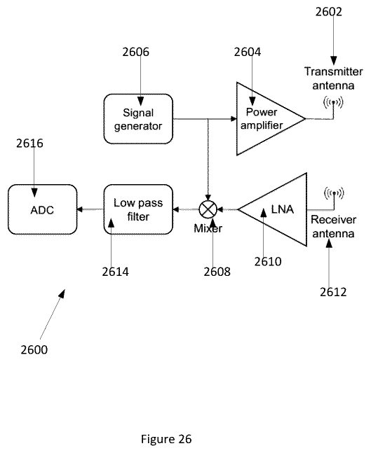

For explanation purposes, the signal processing configuration for the FMCW Infineon radar system operating at 60 GHz is discussed below. FMCW radar systems broadcast an amplified and frequency-modulated electromagnetic signal produced by a signal generator into the environment and then receive the reflected signals from various objects which carry properties such as range and radar cross-section. FIG. 26 shows a common block diagram of the current off-the-shelf FMCW radar modules where both transmitter and receiver are at the same place. As shown the radar system 2600 includes a transmitter antenna 2602 that is connected to a power amplifier 2604 that receives an input from a signal generator 2606. The output of the signal generator 2606 is also supplied to a mixer 2608 that is connected to a low-noise amplifier (LNA) 2610 connected to a receiver antenna 2612. An output of the mixer 2608 is connected to a low-pass filter 2614 which is connected to an analog-to-digital converter (ADC) 2616.

As shown, after amplification of the received signal by the LNA 2610, the mixer 2608 correlates the transmitted and received signals leading to the production of high-frequency and high-frequency signals. The low-pass filter is added to the diagram to filter high-frequency signals in the next block, and then the ADC 2616 is used to convert it to a digital signal which can be processed based on the given information of the designed signal, especially frequency bandwidth.

The signal generator in FMCW radar sweeps in a range of frequency (fₘᵢₙ to fₘₐₓ) linearly with a positive slope of K and a time duration of T and prepares the output signal which is called chirp. The resulted frequency bandwidth, BW, for a chirp is as follows in equation (S1),

$$B W = {f}_{max} - {f}_{min} = K \times T \qquad ( S1 )$$

The frequency bandwidth presented in equation (S1) determines the range resolution of the radar. The relationship between range resolution and frequency bandwidth as presented in equation (S2) shows that the radar with higher frequency bandwidth provides better range resolution.

$$Δ R = \frac{C}{2 BW} \qquad ( S2 )$$

where ΔR is range resolution and C is light velocity in the free space. The range resolution in (S2) discretizes the range of the FMCW radar such that better range resolution provides accurate range estimation and better discrimination between two close reflections. The range in FMCW radar can be estimated from the peak frequency of the reflected chirp signal in the frequency domain by taking Fast Fourier Transform (FFT) of the chirp signal in the time domain that is assumed in equation (S3). Assuming a single reflection with a delay of ta from the environment, results in equation (S4) at the output of the mixer 2608.

$$x ( t ) = A cos ( 2 π {f}_{min} t + π {Kt}^{2} ) , 0 < t < T \qquad ( S3 )$$

$$x ( t ) = A cos ( 2 π {f}_{min} t + π {Kt}^{2} ) \times A αcos ( 2 π {f}_{min} ( t - {t}_{d} ) + π {K ( t - {t}_{d} )}^{2} ) \qquad ( S4 )$$

where α corresponds to the effect of environment and target on the transmitted signal amplitude. By passing through the low pass filter 2614, the resulting signal, or the beat signal, is represented as equation (S5). Considering the low range of the target, t_{d} is much less than t in equation (S5), the beat signal can be simplified as equation (S6). Replacing t_{d}=2R/C, the relationship between the beat and the range of the target, R, can be obtained as equation (S7). By taking the Fast Fourier Transform (FFT) from the signal presented in equation (S7), the range of the target can be determined.

$$x ( t ) = {A}^{2} αcos ( 2 π {f}_{min} {t}_{d} + 2 π K ( {tt}_{d} - {t}_{d}^{2} ) ) \qquad ( S5 )$$

$$x ( t ) ≃ {A}^{2} αcos ( 2 π {f}_{min} {t}_{d} + 2 π {Ktt}_{d} ) \qquad ( S6 )$$

$$x ( t ) ≃ {A}^{2} αcos ( \frac{4 π R}{C} ( {f}_{min} + Kt ) ) \qquad ( S7 )$$

In FMCW radar, the range resolution along with chirp length determines the range of the system. The chirp length can be optimized or improved to remove environmental clutter. Although the near-field measurement requires monitoring the low ranges, more samples benefit from clutter reflection removal. The extra range samples receive the close clutter effects up to the maximum range of the system and then these samples can be removed. In addition, the finer range resolution provides more accurate details of the environment. In one specific experiment, the best achievable range resolution of the employed system, 3 cm, is applied for signal design. By considering this range resolution and the maximum range of the system equal to 1 m, the chirp length, M, can be determined using equation (S8) as equal to 64.

$$M = \frac{{R}_{max}}{2 Δ R} \qquad ( S8 )$$

Using equations (S1) to (S8), the designed signal parameters are summarized in Table S1 below which are used in the signal processing chain. By considering the Pulse Repetition Frequency (PRF) equal to 20 and the sampling frequency of the beat signal equal to 1 MHz, the chirp slope, CS, is obtained as 78.128 MHz/μs which can be supported by the employed system.

Supplementary FIG. S1b depicts the signal processing chain for power calculation in a specific range bin. After ADC, the spectrum of the beat signal, which has peaks determining the targets at various ranges, is obtained by applying an FFT. This FFT can also be considered a range FFT since it reveals a range of reflections. Each range FFT bin corresponds to a range interval discretized by range resolution. For instance, if the range resolution is 3 cm and a target range is 20 cm, this target will appear in the 7th range bin. By collecting N consecutive chirps over time and putting them into a matrix, the range-time matrix is created. This matrix has M rows corresponding to all numbers of range bins and N columns corresponding to the number of chirps. Then, the desired range based on the experiment is selected and the power is calculated for that range bin.

TABLE S1
The designed signal parameters

| Parameter | Quantity | Value | |
|---|---|---|---|
| PRF | pulse repetition frequency | 20 | |
| BW | signal chirp bandwidth | 5 | GHZ |
| ΔR | radar range resolution | 3 | cm |
| Rₘₐₓ | maximuin range of system | 96 | cm |
| M | chirp length | 64 | |
| f [symbol] | beat signal sampling frequency | 1 | MHz |
| CS | chirp slope | 78.128 | MHz/μs |

[symbol]

indicates data missing or illegible when filed

Algorithm 81 Power Calculation Algorithm

```
Input: Range-time Matrix in the Frequency Domain and Selected Range
Bin
Output: Power Calculation
counter = 0
Sum = 0
for i in range (1, N): do
  counter = counter + 1
  selected sample = Beat signals in the frequency domain
  (selected range bin)
  sum = sum + selected sample
  Power = sum / counter
  Return Power
```

As shown in FIG. 8d (which is a photograph showing the setup for measurement equipment for the testing of the scenario schematically shown in FIG. 8b), a probe working at 60 GHz is connected to a spectrum analyzer supporting the frequency range up to 110 GHz and is used for power measurement. A Pyrex beaker filled with 10 ml pure water is utilized to be placed on top of the metasurface array with a half-wavelength, 2.5 mm, distance above the radar antenna. The experiment is repeated for the radar system without a metasurface such that very thin cardboard is replaced with the metasurface at the exact location to maintain the beaker at a specified distance above the radar surface. In both cases, the probe is immersed into the beaker with a 1-mm distance above the beaker's bottom surface, which is 2 mm above the metasurface layer location.

The measurement results showing the power transferred into the water medium and picked up by the probe are presented and compared in FIG. 11a which is a graph showing the measured near-field power density incident by the radar system inside the beaker-filled with pure water in the presence or absence of the designed transmissive metasurface. As can be seen, use of a metasurface enhances the power received by the probe at the operational radar frequency range, from about 59.7 to 61.7 GHZ. Fluctuations in the enhanced transferred power result from both the distribution of radar power and specific design considerations. Looking specifically at the designed frequency of 60 GHz shows an improvement of 11 dB in the measured near-field power, which is in good agreement with the simulation results representing the power density improvement of 11.5 dB in FIGS. 9c and 9d.

The next step is the radar SNR investigation by measuring the reflected power from the water to one of the radar receiver antennas (R_{X3}). Equation (S1) was used to measure the received power in a period of time in the cases of the radar system loaded by a beaker filled with water in the presence or absence of the transmitarray metasurface. To illustrate near-field sensing improvement with higher SNR, different concentration levels of sugar are added to water and the results are analyzed and compared in FIG. 11b which is a graph showing an investigation of the measured power reflected from the beaker filled with pure water received by R_{X3} radar antenna over a period in the presence or absence of the designed transmissive metasurface for different concentration levels of sugar.

As shown, using a metasurface, such as near-field focused metasurface, enhances the power reflection from the pure water by 11.3 dB and improves the radar SNR around 13.4 times, which is in good agreement with the simulation results presented in FIG. 9e. Furthermore, in this experimental study, the effect of varying the dissolved amount of sugar in water in the presence of the metasurface is explored. 200 experiments for each scenario were carried out to provide high repeatability. Although power reflection is reduced by increasing sugar content in both cases, the metasurface clearly improves the received power level by the radar as shown in

FIG. 11b. The received power in the presence of the metasurface for different sugar concentration levels has a resolution of around 0.5 dB per 15 mg/ml concentration, validating that the metasurface enhances the overall sensing functionality. Table 1 below provides a comparison descriptions to thoroughly discuss and emphasize the novelty and advantages of the proposed method using the designed metasurface.

In experiments, it was determined that embodiments of the disclosure provide advances in biomedical sensing technology, enabling continuous, real-time monitoring of vital signs, glucose levels, and health metrics that can provide early diagnosis, improve treatment, and ultimately save lives.

TABLE 1
Novel features and advantages of utilizing the transmissive
metasurface method for biomedical sensing

| Features | Descriptions |
|---|---|
| Near-Field Theory | The metasurface is designed with a methodology tailored for near-field |
| Considerations | radiation theory, essential for biomedical sensing, in contrast to prior works |
| | focusing on usual far-field antenna radiation. |
| Compactness | In near-field focusing, current antenna designs face integration challenges |
| | with low-profile radar due to their bulky structures. This paper proposes a |
| | low-profile, compact, and planar metasurface for seamless integration with |
| | a radar system. |
| Millimeter-wave | The mm-wave frequency range is selected for its high resolution and |
| Operation | precision, bio-compatibility, and reduced interference making it suitable for |
| | applications in wearable devices like smartwatches. |
| Direct Human Skin | Near-field studies typically focus on antenna radiation in free space, but |
| Contact | the human body causes detuning and impedance mismatching, degrading |
| | performance. Existing methods are unsuitable for direct-contact biomedical |
| | applications. The designed metasurface allows skin contact, enabling precise |
| | targeting without interference. |
| Impedance Matching | The metasurface is carefully designed based on impedance matching network |
| Layer | theory to achieve highly effective impedance matching between free space |
| | and the human skin. This design tackles a significant challenge in the |
| | literature by minimizing reflections arising from air-skin interference. |
| Intensify Radiated | The metasurface, with phase synthesized unicells significantly boosts the |
| Near Electric Field | near-field electric field from the source antenna, achieving an 8.8-fold im- |
| | provement within the proposed skin phantom medium compared to the |
| | radar antenna without the metasurface. |
| Intensify Near field | The metasurface enhances absorbed power in human skin at 60 GHz with- |
| Transmitted Power | out affecting source antenna impedance matching. This near-Bell focused |
| | design yields an 11 dB improvement in radiated power density above the |
| | metasurface within the proposed skin phantom modium. |
| Intensify Near-feld | Analyzing the radar's reflection coefficient shows the metasurface amplifying |
| Reflected Power | reflected power from human skin by 11.3 dB. This enhancement leads |
| | to a notable 13.4- times improvement in radar SNR, enabling effective information |
| | transmission and high-performance sensing in biomedical applications. |
| Glucose Sensing | In glucose monitoring, metasurface-enhanced power measurements show a |
| Enhancement | resolution of around 0.5 dB per 15 mg/ml sugar concentration, maintaining |
| | a high SNR and confirming enhanced functionality in glucose sensing |

To overcome the existing limitations of bioelectronic interfaces, embodiments of the disclosure include a metasurface, which in some examples may be a subwavelength-structured metasurface, to manipulate electromagnetic fields surrounding the human body. In the embodiments above, the metasurface was, a low-profile planar near-field-focused metasurface for integration with radar transmitter (T_{X}) and receiver (R_{X}) antennas, allowing it to directly contact the human skin for real-time, noninvasive blood glucose monitoring. This integration increases the absorbed power density from the radar antenna at a single focal point within the skin medium, while also enhancing the power reflected back from the skin to the radar and boosts the sensor's overall signal-to-noise ratio.

In the current embodiment, the metasurface may be seen as a being part of a near-field multi-focusing system for biosensing that enables data collection from multiple focal points at varying depths, enhancing the detection of dielectric changes in biological tissues and improving the signal-to-noise ratio by reducing noise and inconsistencies. The multi-focus radar system provides embodiments that account for physiological variations, such as skin thickness and hydration levels, which would otherwise impact signal quality.

Multi-focusing refers to the radar's capability to accurately control the directionality of antenna beams, enabling the detection of multiple targets through beamforming techniques. In the following, two approaches are provided with respect to generating focal points at different polarizations or at distinct frequencies. The design of a reflecting array capable of producing two adjacent beams per feed with orthogonal polarization is known, however, differentiating focal points by polarization is unfeasible for near-field sensing, where all polarizations coexist and cannot be effectively isolated, as in far-field applications. This limitation makes a multi-band, multi-focus metasurface a more suitable solution, enabling each focal point to operate at a distinct frequency. Adopting this multi-band approach in multi-near-field focusing allows precise energy focusing at multiple depths or regions within the skin, improving both penetration and measurement accuracy in biosensing applications.

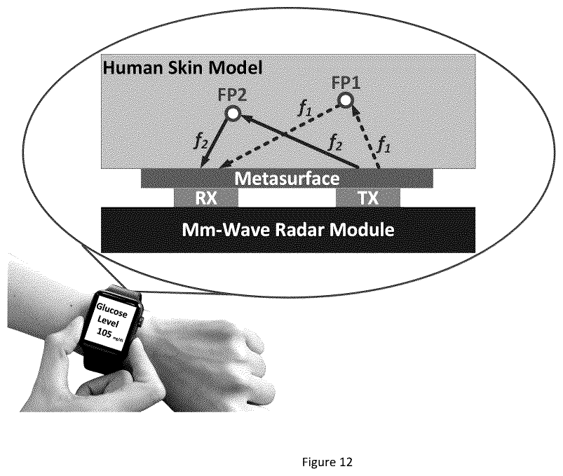

Turning to FIG. 12, a schematic diagram of a multi-focus system using a metasurface for biomedical signal sensing applications is shown. The embodiment of FIG. 12 is similar to the embodiments or FIGS. 1b and 1c with a different metasurface. The metasurface of the current embodiment maybe seen as a dual-band, dual independently-tunable near-field focus metasurface. In some embodiments, the metasurface enhances performance of mm-wave radar-based biosensor, to match the specific characteristics of human skin, such as the wrist in the case of a Smartwatch. This metasurface enables dual focusing of absorbed power within human skin, achieved through a phase-synthesized analysis of the metasurface array, where each focal point is controlled by a distinct frequency band within the radar spectrum. The integration of the metallic slot metasurface with an Infineon radar TX/RX antennas results in a 14.7 dB and 12.4 dB increase in Poynting power density at two distinct points within a human skin phantom model, along with an increase in radar-received power by 11 dB and 12.7 dB at 58.5 GHz and 61.7 GHZ, respectively, significantly enhancing the radar's bio-sensing capabilities.

With respect to dual-band, dual near-field focus metasurface, in one embodiment of a metasurface, the metasurface may include a dual-band unitcell and phase-synthesized array analysis to achieve near-field phase shift compensation. This design is intended for direct contact with human skin and is considered to operate within the mm-wave range, specifically targeting two distinct frequency bands within the radar spectrum from 58 to 63 GHZ.

A design strategy for a dual-band transmissive array employing interleaved electric and magnetic dipole slots to minimize or reduce mutual coupling, which enables two frequency bands with adjustable separation. The design uses metallic layers without a substrate, enhancing efficiency and achieving a narrower bandwidth that allows closer frequency band placement through precise filtering. This results in S-parameters with a higher quality factor and minimal or low unwanted resonances within the targeted frequency bands. Additionally, the fabrication cost is reduced by utilizing laser cutting techniques, making this approach both efficient and low-cost.

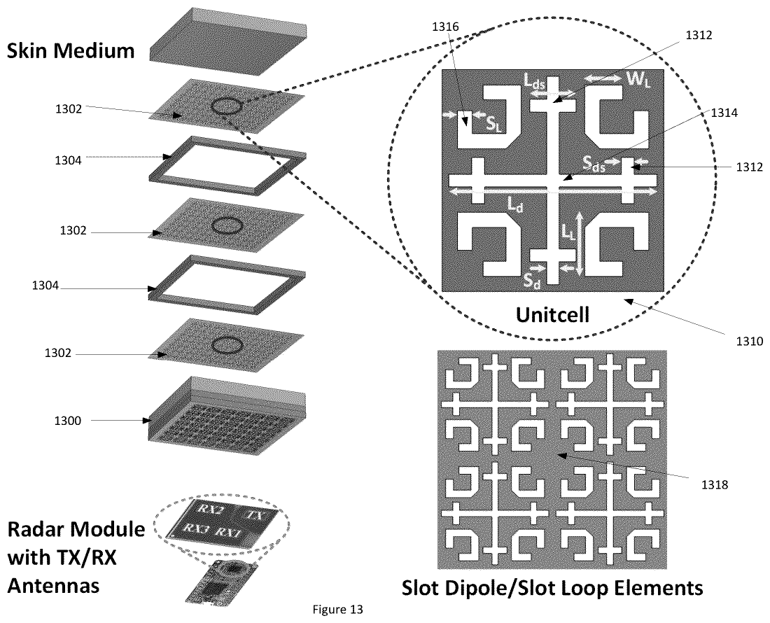

A schematic diagram of a unitcell for use in the metasurface of FIG. 12 is shown in FIG. 13. As shown in a solid view and an expanded view on the left hand side of FIG. 13, the metasurface 1300 includes a set of metasurface layers 1302 with frame layers 1304 or fixtures therebetween. The frame layers 1304 may be made from a dielectric substrate material and are used to provide spacing between the metasurface layers 1302. While the current embodiment shows a metasurface 1300 including three (3) metasurface layers, it is understood that other embodiments may include two or more metasurface layers with corresponding frame or fixture layers 1304 between each pair of adjacent metasurface layers 1302.

Within each metasurface layer are a set of unitcells 1310 that are arranged in an array, such as a N×N array. N may be selected based on a desired size of the metasurface and, in some specific embodiments may be seven (7). Unlike the unitcells discussed above with respect to FIG. 4a or 4c, the unitcell of the current embodiment is made from a metallic material with slots or openings etched or formed within the unitcell as discussed below.

The metallic unitcell 1310 includes a set of end portions slots or openings 1312 that are located proximate the sides of the unitcell 1310 and are connected via a cross-shaped slot or opening 1314 that, in the current embodiment, is located centrally within the unitcell 1310. In the current embodiment, ends of the cross-shaped portion 1314 extend past the end portions 1312 but in other embodiments, the ends of the cross-shaped portion 1314 may terminate at the end portions 1312. The unitcell 1310 further includes a set of somewhat circular corner slots or openings 1316 that are located in the corners of the unitcell 1310 and are somewhat divided by the cross-shaped portion 1314.

When the unitcells are placed in the array (or positioned to manufacture or create the metasurface layer), adjacent unitcells 1310 create a somewhat square loop or loop element 1318 that is formed by the somewhat circular corner portions 1316 of the adjacent unitcells 1310. This is schematically shown in the bottom right of FIG. 13. For the current embodiment, each of the metasurface layers 1302 are identical.

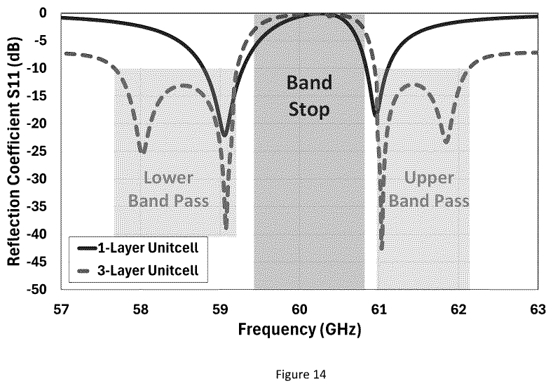

For this specific embodiment, the unitcell layout for mm-wave operation in FIG. 13 may be seen as a dual-band metasurface unitcell with independently tunable frequency bands. As shown, an electric crossed-dipole slot element loaded with stubs is employed to create a band-pass filter at the operational frequency of 59 GHZ, however, other operational frequencies are possible and contemplated. By tuning the length of the dipole slots, L_{d}, and the stub length, L_{ds}, as well as its positions, the center frequency of this band can be controlled for other operational frequencies. To establish the upper frequency band, the square loop slot element 1318 functions as a band-pass filter at the operational frequency of 61 GHZ. Adjusting the dimensions of the etched branches within the loop slot or corner elements 1316, W_{L} and L_{L}, enables control over the upper frequency band. In one specific embodiment, the design parameters are as follows: L_{d}=2.16, S_{d}=0.13, S_{ds}=0.13, L_{ds}=0.48, L_{L}=0.66, W_{L}=0.39, S_{L}=0.15 (all in mm). FIG. 14 presents the S-parameter (S11) analysis of the slot elements at the designated frequency bands.

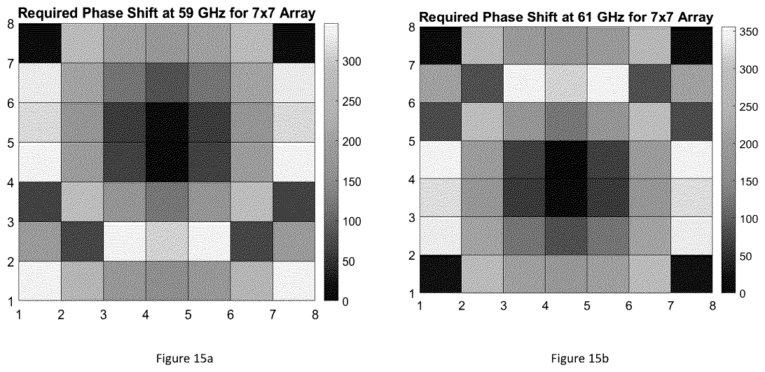

To construct the metasurface array using the dual-band unitcell of FIG. 13, it is necessary to achieve the desired phase shift across both frequency bands, with each unitcell tuned to provide the appropriate phase compensation based on its position relative to the radar T_{X} antenna. In this design, the metasurface utilizes Fabry-Perot resonance theory by positioning the radar antenna and metasurface interface at a distance of half the free-space wavelength. The required phase shift for a 7×7 array of square unitcells, each with dimensions of 2.3 mm², at a feed focal point distance of 2.5 mm is illustrated in FIGS. 15a and 15b. To achieve the dual-focusing capability, the phase of the array is adjusted to direct power to distinct focal points within the human skin model, each at a specific frequency. FIGS. 15a and FIG. 15b show the necessary phase compensation for near-field focal point tilting at angles of =+20 and =−20 degrees at the lower and upper frequency bands, 59 GHZ and 61 GHZ, respectively. As shown in FIG. 15, the dual-band unitcell depicted in FIG. 13 provides phase shift compensation of 330 degrees at 59 GHz and 350 degrees at 61 GHz to achieve the required array phase synthesis. This is accomplished by fine-tuning the dimensions of the dipole and loop slot elements. In designing a transmissive array, a transmission coefficient of 3 dB enables a maximum or high phase shift of up to 360 degrees for a three-layer metasurface unitcell, irrespective of the structure's shape. In this design, three metallic layers are considered with an air gap of λ/4, resulting in a compact metasurface with a total thickness of 2.54 mm for direct contact with human skin. The skin medium is modeled as a dielectric slab with a 3 mm thickness and dielectric properties of ϵᵣ=7.98 and σ=36.4 S/m. FIG. 14 shows the S-parameters analysis of the 3-layer unitcell. Compared to the single-layer design (or the previously described metasurface), the unitcell of FIG. 13 demonstrates a wider bandwidth and a slight shift in the center frequencies of both assigned bands, resulting from phase error losses due to the averaged air gap distance between the metasurface's metallic layers.

With respect to radar module integrated with the designed dual-band dual-near field-focus metasurface, as shown in FIG. 13, the Infineon BGT60TR13C radar, operating within a frequency range of 58 to 63 GHZ, includes four on-chip antennas, one functioning as the transmitter and the others as receivers. The radar antenna surface is placed at an average distance of 2.5 mm, accounting for variations in phase center location across frequencies. Although the antenna phase center shifts with frequency, this dual-band design approximates the phase center at 60 GHZ, introducing a minor phase error loss at both targeted frequency bands.

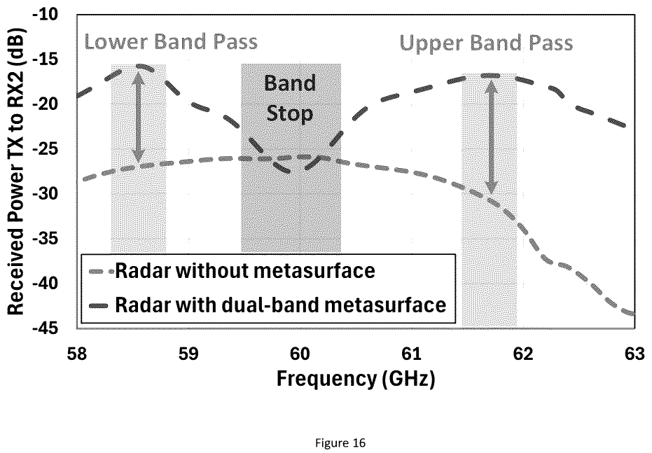

FIG. 16 displays the received power at the radar antenna receiver, R_{X2}, which captures data from within the skin medium following excitation by the Tx antenna, and compares the S-parameters (S₂₁, T_{X} to R_{X2}) for the radar module with and without the integrated dual-band metasurface. The results clearly demonstrate the dual-band metasurface's effectiveness in enabling two distinct frequency bands within the radar spectrum. Specifically, the metasurface increases the received power level by 11 dB at 58.5 GHz and 12.7 dB at 61.7 GHZ, while significantly suppressing power at 60 GHz by 11.7 dB relative to the highest peak.

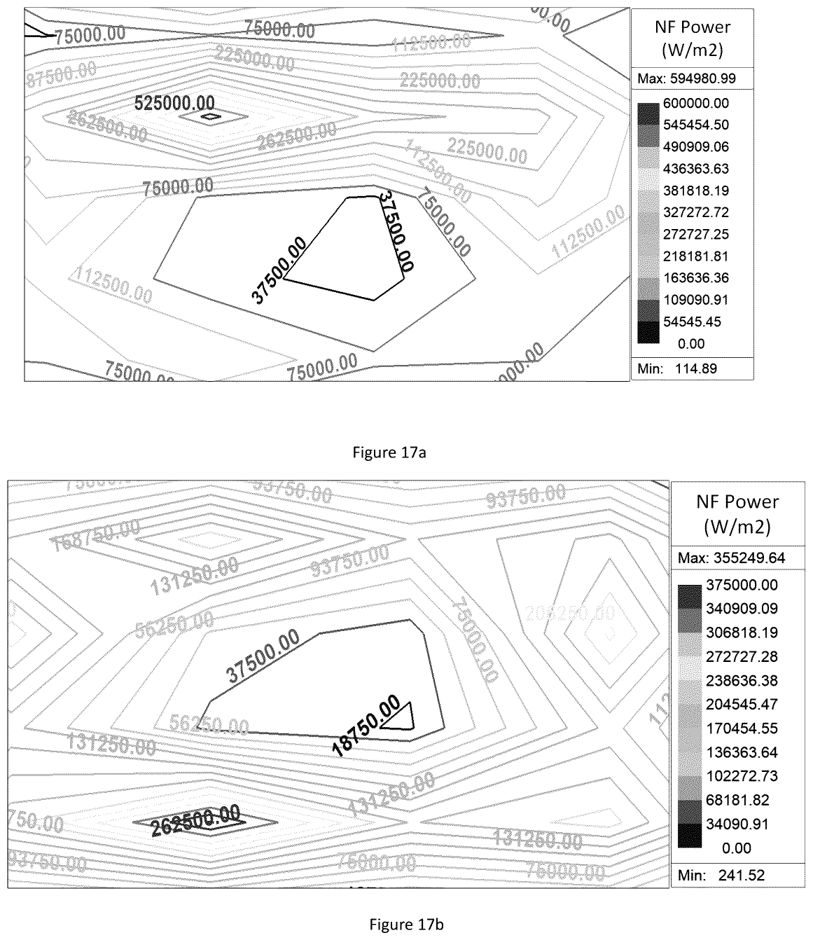

After analyzing the dual-band capability of the designed metasurface, it is beneficial to control each frequency band to focus transmitted power and capture data from distinct locations within the human skin. FIG. 17a and FIG. 17b are 2D contour plots of the power density radiated by the T_{X} radar antenna integrated with the metasurface of FIG. 12 or FIG. 13, positioned on a plane parallel to the array at a distance of 2 mm, at 58.5 GHZ and 61.7 GHZ, respectively. As shown in these figures, the focus points within the human skin are symmetrically distributed along x-axis as designed for ±20 degrees; however, focus tilting is also observed along the y-axis. This effect arises because the radar TX antenna is not centrally positioned relative to the array, disrupting the symmetry assumed in the phase synthesis analysis and leading to deviations in the assigned near-field focal points. Compared to the near-field Poynting power generated by the radar TX antenna without the metasurface, which is measured at 20,065 W/m², the designed metasurface significantly enhances power absorption within the skin medium, achieving 594,980 W/m² at 58.5 GHZ, a 14.7 dB improvement, and 355,249 W/m² at 62 GHZ, corresponding to a 12.4 dB near-field power enhancement. By examining deeper penetration into human skin, it is observed that the power enhancement level at 58.5 GHz reaches 12.2 dB at a depth of 2.1 mm, while maintaining the same focal point location. Conversely, at 61.7 GHZ, deeper penetration results in lower power density and a more dispersed focus over the surface. For a system using the metasurface of FIG. 12, two approximately symmetrical focal points within human skin were achieved, as schematically shown in FIG. 17, to capture data from different locations.

Expanding beyond dual-focusing to incorporate multiple focal points introduces the need for a multi-band metasurface design. In the following, another embodiment of a metasurface for us in radar sensing that enables near-field scanning system for data capture across multiple skin locations is taught.

In one embodiment, the multi-radar bio-sensor system can be implemented using the metasurface including unitcells of FIG. 4c operating at a specific frequency across all radar modules, with location adjustments solely for data recording purposes. In another embodiment, the multi-radar biosensor system (as described below) may be seen as a frequency-scanning multi-radar system with multi-band non-interleaved metasurfaces whereby each metasurface is adjusted or customized for a specific frequency band to capture data from various skin locations and from different penetration depths.

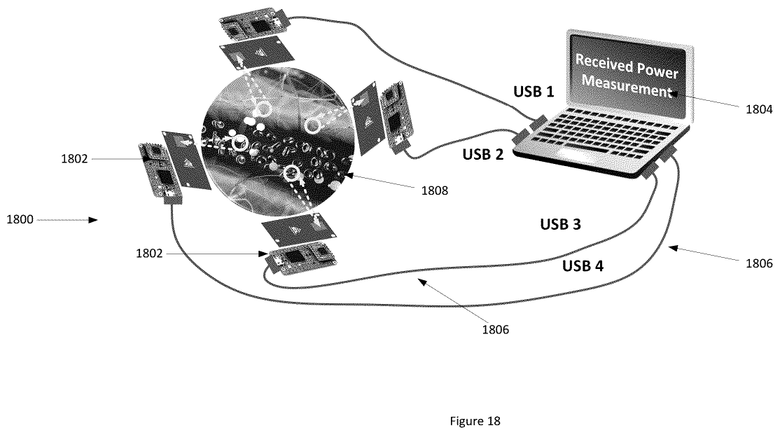

As schematically shown in FIG. 18, which may be seen as a metasurface-enhanced multi-radar near-field system, the system 1800 includes a set of radar units 1802 that are positioned to gather data from different angles and positions. Each of the radar units 1802 are connected to a processor 1804 (which in the current embodiment is a laptop) via cables 1806 which enable communication between the radar units 1802 and the processor 1804. A single metasuface (although there may be a metasurface for each radar system) 1808 located proximate the individuals body or an area of interest enhances the radar sensing as discussed above. The positioning of each of the set of radar units increases the robustness and accuracy of the detected signals whereby averaging measurements from various locations helps mitigate or reduce the impact of local physiological variations, including differences in skin thickness, tissue composition, and blood flow.

FIG. 18 shows that each radar module 1802 in the metasurface-enhanced multi-radar system 1800 may be fully synchronized by connecting to a distinct USB COM port on a laptop 1804, enabling simultaneous data capture from different locations within the radar's operational frequency range. This configuration allows for space scanning without the need to physically move the entire system. Instead, scanning is achieved through the collective operation of multiple bio-sensing radars.

By simultaneously capturing data from multiple distinct locations and employing advanced signal processing algorithms for multi-radar synchronization, in some embodiments, the system 1800 mitigates or reduces intrasubject and intersubject variability caused by differences in skin composition, blood flow, and environmental factors, enhancing spatial coverage, compensating for inconsistencies, and providing a more reliable assessment of biomedical conditions. Experimental results demonstrated that the fusion-based system 1800 outperforms radar-only solutions, achieving up to about 2.4-times improvement in radar SNR when addressing blood glucose distribution inconsistencies with a 20% glucose concentration variation across different skin phantoms.

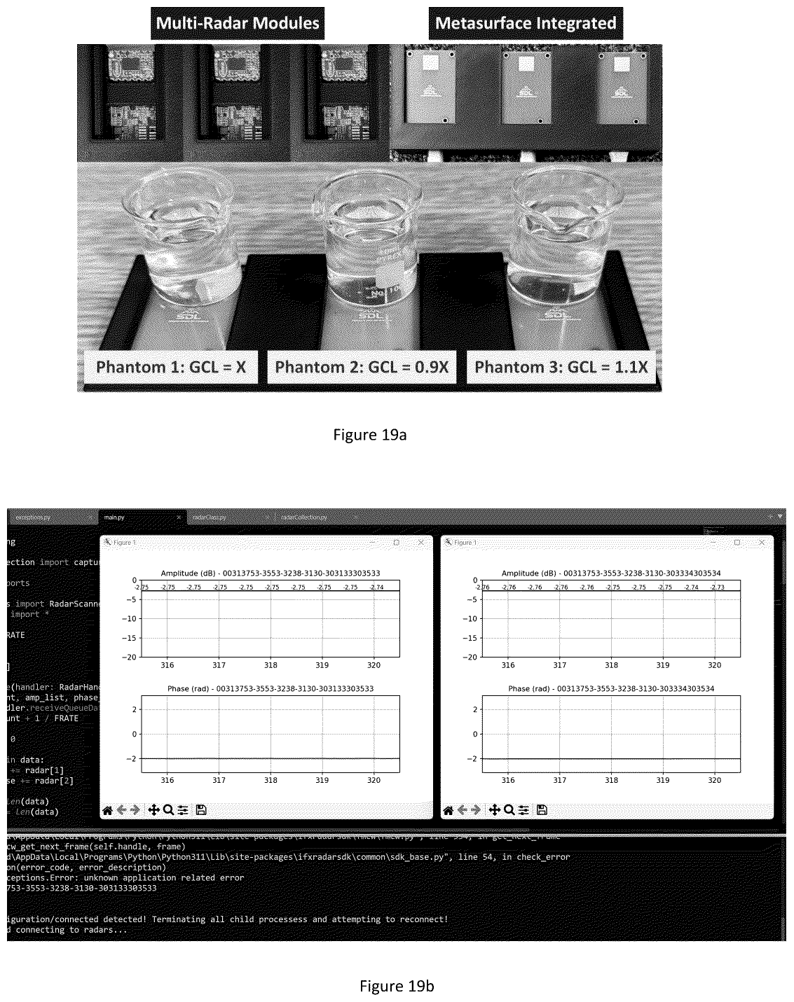

With respect to a synchronized multi-radar biosensor, the objectives of this multi-radar fusion system for non-invasive glucose monitoring are to achieve synchronization of radar operations, ensuring concurrent performance without delays to enhance measurement accuracy, and to enable real-time system visualization for immediate monitoring and analysis. As shown in FIG. 19a, in one embodiment, the multi-sensor configuration includes three single-focus metasurface-enhanced radars, each connected to a laptop USB port. For the experiment, the radars were controlled and synchronized so that they started simultaneously. Measurements were conducted on three phantoms (beakers of water), each with a different glucose concentration, to assess the system's efficacy. The results from the multi-focus metasurface sensing system 1800 can be displayed for each radar individually or by averaging the power across the entire system. As shown in FIG. 19b, the program plots real-time amplitude and phase data for each connected radar.

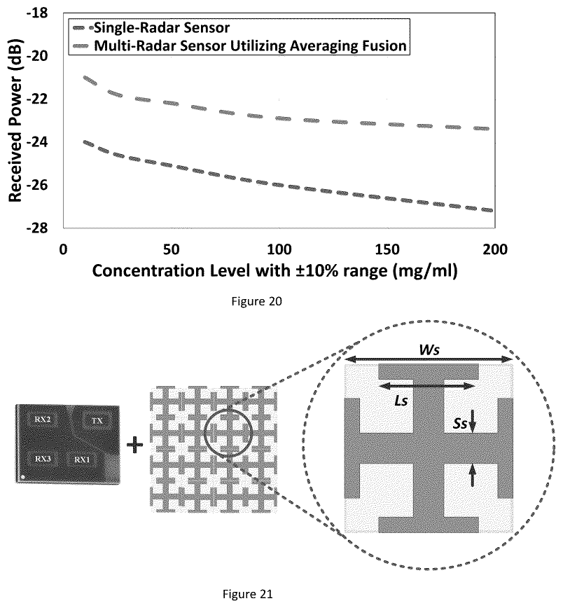

A multi-concentration testing approach was implemented to evaluate performance of the system 1800, glucose phantoms with adjusted concentrations of 10 mg/dl, 25 mg/dL, 50 mg/dl, 100 mg/dL, and 200 mg/dL were prepared, with additional solutions incorporating a 20% (±10%) concentration variation, as schematically illustrated in FIG. 19a. The signal response was analyzed by measuring the reflected power amplitude variation, initially using a single sensor and then with a multi-sensor array to compare accuracy. The results presented in FIG. 20 demonstrate that the multi-sensor configuration 1800 enhances detection sensitivity by improving the radar signal-to-noise ratio (SNR) by 2.8 to 3.8 dB across the tested concentration levels.

This demonstrates that synchronized multi-radar fusion system enhanced by a metasurface provides robust and reliable tracking under dynamic conditions. The multi-radar approach enhances spatial coverage, reduces measurement uncertainties, and ensures consistent data acquisition, making it well-suited for real-life applications requiring accuracy, stability, and resilience.

With respect to radar sensing enhancement through biosensor fusion with a multi-band non-interleaved metasurface, multi-radar sensing significantly enhances accuracy and sensitivity in non-invasive, real-time health monitoring.

The metasurface of this embodiment (using unitcells as schematically shown in FIG. 21) utilizes discrete zones within a transmissive metasurface, each including phase-synthesized arrays. These zones function as low-profile impedance-matching networks, optimized for specific frequencies within the millimeter-wave radar range. This increases efficiency by enhancing absorbed power density at various frequencies, enabling different penetration depths into human skin. The selection of an optimal microwave frequency range for radar-based bio-sensing applications is governed by several crucial factors, including the required tissue penetration depth and the specific resolution needs of the diagnostic application. Employing a spectrum of frequencies in bio-sensing not only exploits their diverse penetration depths and resolution capabilities but also leverages the distinct ways each frequency interacts with different tissue components.

Each radar in the system is integrated with a uniquely designed planar transmissive metasurface, specifically tuned to distinct frequencies within the 58-63 GHz operational range. These metasurfaces, coupled with on-chip antennas, maintaining direct contact with a human skin model. This configuration is particularly effective for detecting glucose level variations across the skin's surface. By leveraging targeted frequencies, the system improves penetration and interaction with skin tissues, enabling more reliable and precise glucose monitoring—an essential advancement for managing conditions such as diabetes.

Use of frequency-dependent focusing may ensures that each operational frequency achieves a high efficiency and effectiveness, thereby enhancing the overall performance of the biosensing system. Analysis using a customized phantom, closely resembling human skin, demonstrates significant increases in near-field absorbed power density: over 11 dB at 60 GHz and 2 mm penetration depth, over 17 dB at 58 GHZ, and 9 dB at 61 GHz at the same depth.

Employing transmitarray theory, utilizes the commercially available Infineon radar chipset, which serves as the feed for the transmitarray, operating within a frequency range of 58 to 63 GHZ. To achieve higher accuracy, a near-field-focused (NFF) metasurface, regarded as a transmissive phase-synthesized array, can be implemented at various operational frequencies and integrated with each radar module, as demonstrated in FIG. 18. This integration leads to the creation of a biomedical multi-radar system, which is capable of significantly increasing the near-field power density into the body, that is achieved without disturbing the antenna impedance matching, while simultaneously improving radar sensing capabilities by enhancing the amount of power reflected from the body back into the R_{X} antenna. As a result, each radar system experiences a boost in the signal-to-noise ratio (SNR), significantly improving the performance of the overall system.

For the embodiment of FIG. 18, the metasurface functions as a frequency selective surface (FSS), controlling the specific frequency range for each radar module. This setup is important because restricting the radar's frequency range to a single frequency during signal processing would necessitate a significant reduction in bandwidth, potentially degrading radar range resolution and affecting the accuracy of the Doppler frequency shift measurements. This arrangement allows for the collection of health data at various penetration depths due to the use of different frequencies.

When discussing whether each radar system should utilize multi-band metasurfaces or allocate specific frequency bands to individual radars using non-interleaved metasurfaces, it is beneficial to consider the benefits of adhering to FCC-regulated, designated 500 MHz bands within the 60 GHz range for mm-wave FMCW radars. Operating within these specified segments, rather than across the entire 5 GHz bandwidth, greatly enhances spectrum efficiency and reduces interference in this densely populated band. This focused approach not only boosts radar performance through tailored optimization for specific frequencies but also simplifies regulatory compliance and device design. Furthermore, the multi-band non-interleaved metasurface effectively increases the impedance matching between air and human skin at each frequency within the radar range, thereby improving power absorption levels within the skin at each specific frequency.

For a specific embodiment, a partial section of the metasurface array, including its square unitcell, is designed to operate at specific frequencies in the radar range from about 58 to 63 GHz with 1 GHz increments and is integrated with Infineon BGT60TR13C radar antennas, as depicted in FIG. 21. A full-wave simulator is used to evaluate the impedance matching of the unitcell at the proposed frequencies, utilizing Floquet port analysis for the infinite array design. For biomedical applications, the human body skin is modeled as a dielectric slab that contacts the metasurface unitcell directly, without any air gaps. The simulation takes into account the actual characteristics of human body skin, permittivity and conductivity, at their respective frequencies, as detailed in Table 2. The dimensions of the designated unitcell for operating at each frequency band in direct contact with a human skin model are specified as follows: at 58 GHZ, Wₛ=1.5, Lₛ=0.8, Sₛ=0.2 mm, at 59 GHZ, Wₛ=1.2, Lₛ=0.8, Sₛ=0.2 mm, at 60 GHZ, Wₛ=1.1, Lₛ=0.65, Sₛ=0.2 mm, at 61 GHZ, Wₛ=0.97, Lₛ=0.65, Sₛ=0.2 mm, at 62 GHZ, Wₛ=0.75, Lₛ=0, Sₛ=0.1 mm, at 63 GHZ, Wₛ=0.715, Lₛ=0, Sₛ=0.1 mm.

TABLE 2
Variations in the dielectric properties of the
human body's skin model in response different
frequencies within the radar range of 68 to 63 GHz

| Frequency (GHz) | Permittivity | Conductivity (S/m) |
|---|---|---|
| 58 | 8.21 | 36.1 |
| 59 | 8.09 | 36.3 |
| 60 | 7.98 | 36.4 |
| 61. | 7.86 | 36.5 |
| 02 | 7.76 | 36.7 |
| 63 | 7.65 | 36.8 |

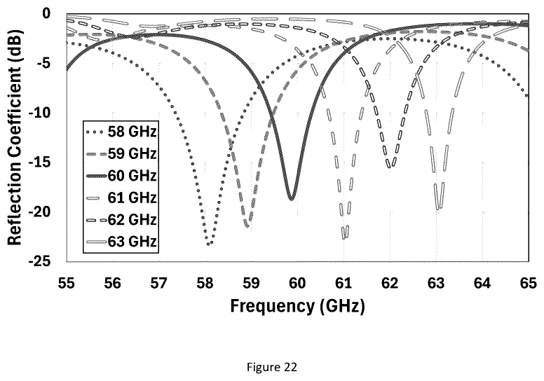

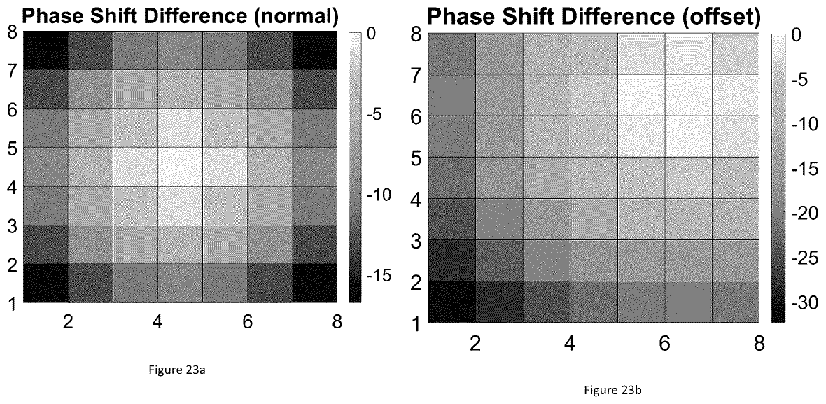

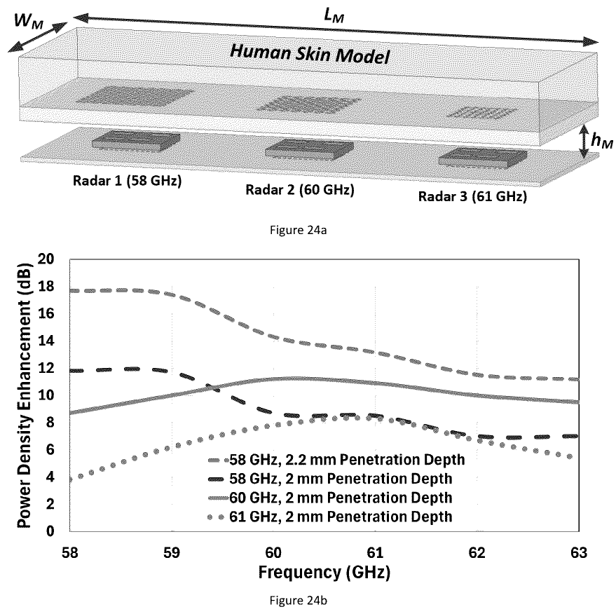

FIG. 22 illustrates the reflection coefficient analysis of the designed unitcells at distinct frequencies ranging from about 58 to 63 GHZ, when in direct contact with the human body skin medium, taking into account the characteristics listed in Table 2. As depicted in FIG. 22, each unitcell achieves an appropriate reflection coefficient at the air-skin interface, demonstrating effective impedance matching when operating in contact with the skin medium, rather than in free space.

To produce the desired beam shape on the opposite side of the metasurface layer in a specific near-field location, each unitcell is designed to introduce a specific phase shift to the incident electric field, while maintaining the magnitude at a level close to its highest point or level. The expanded phase shift for a multi-radar, multi-band system accounts for the unique operational characteristics of each radar unit across various frequency bands,

$${ϕ}_{mn}^{ij} = \frac{2 π}{{λ}_{ij}} [ \sqrt{( {x}_{m i}^{2} + {y}_{ni}^{2} + {r}_{0 ij}^{2} )} - {r}_{0 ij} ] + {ϕ}_{0 ij} \qquad ( 9 )$$

where each radar i and its corresponding frequency band j are considered independently. For every element, the required electric field phase shift, ϕ^{ij}ₘₙ, is determined to ensure that all element contributions coherently align in phase at the near-field focal point F=(0, 0, r₀ᵢⱼ), positioned along the normal to the array plane. The variable λᵢⱼ denotes the wavelength associated with the j-th frequency band of the i-th radar, reflecting the system's ability to operate across multiple frequencies. The coordinates xₘᵢ and yₙᵢ define the spatial location of the (m, n)-th element within the i-th radar's array. Additionally, ϕ₀ᵢⱼ, the initial phase for each radar-band pair, accounts for calibration offsets or inherent system variations.

The dimensions of the array unitcells are determined by calculating the required phase delay compensation for the electric field at the target frequency, using equation (9) at the planar aperture at the metasurface's location. This enables an equal-phase superposition of the propagated fields at the focal point in the near-field region, allowing the system to operate effectively across various locations and frequencies on skin. Using equation (9), the required E-field phase compensation ranges at the aperture, assumed to be at the metasurface location with (r₀ᵢⱼ=2.5 mm), are determined. The phase shift necessary for each metasurface, which utilizes a (7×7) array of unitcells, is considered for six distinct frequencies of 58, 59, 60, 61, 62, and 63 GHz.

Considering the other parameters in equation (9) fixed, the required phase shift varies directly with frequency. When a wideband radar antenna is used, the phase difference between the first and last frequency bands becomes significant, resulting in high phase error loss and reducing the radar sensing efficiency at these frequencies. In the structure presented in the first section, the radar module antennas operate across a wide frequency range of 58 to 63 GHZ; however, the near-field-focused metasurface is optimized for operation at 60 GHZ. After applying phase synthesis analysis on the metasurface array at 60 GHZ, the phase-shift difference between the required values at 58 GHz and 63 GHz is approximately 17°, as shown in FIG. 23a which is a plot of the phase shift differences required for mapping the metasurface array using the metasurface of FIG. 18 between 58 and 63 GHz when the feed is aligned with the center of the array. In addition, it should be noted that the analysis above assumes the feed location is aligned with the center of the array. However, in most practical cases, such as with the Infineon BGT60TR13C radar antennas, the Tx antenna is positioned at the corner and illuminates the metasurface at an offset angle, resulting in oblique incident waves. This offset causes a significant increase in the phase difference. As shown in FIG. 23b (which is a plot showing phase shift differences required for mapping the metasurface array using the metasurface of FIG. 18 between 58 and 63 GHZ when the feed is located at a 2 mm offset, a 2 mm offset results in a 32° phase difference. A 5 mm offset further increases the phase difference to approximately 380° between the required phase shifts across the 58 to 63 GHz frequency range, when using a 7×7 array.

To reduce the phase error, a triple biosensing radar system is considered that is integrated with a multi-band, non-interleaved metasurface, as illustrated in FIG. 24a. The optional frequencies of 58, 60, and 61 GHz are chosen to assess the metasurface's capability to enhance the power density level within human skin at different frequencies. As shown in FIG. 24b, the 60 GHz metasurface can increase the power density at a 2 mm penetration depth by 11.5 dB, with performance decreasing at both lower and higher frequencies.

Decreasing the frequency to 58 GHZ and using a 58 GHz metasurface specifically designed for this frequency increases the penetration depth as expected. At the same measurement point as the 60 GHz metasurface, the 58 GHz metasurface provides a maximum or high power enhancement of 11.8 dB at 58 GHz. However, at a penetration depth of 2.2 mm, this metasurface focuses the power absorption even higher, reaching a maximum power enhancement of 17.7 dB at 58 GHZ.

This analysis shows that using the 58 GHz metasurface not only increases the power density inside human skin but also increases the penetration depth. Furthermore, utilizing the 61 GHZ metasurface results in a maximum or high power enhancement of 8.3 dB at a penetration depth of 2 mm. As expected, at 61 GHZ, the power density is higher at shallower depths, so at the same depth level as the 60 GHz metasurface, it provides lower power enhancement. This analysis highlights the potential of using variable frequencies to target multiple skin sites, significantly enhancing the detection of blood glucose variations and the identification of physiological parameters by providing more comprehensive data.

It is noted that the metasurfaces operating at the three selected frequencies do not have the same aperture size, which impacts the results. As the number of elements increases, it is beneficial to enhance the phase-shift capability of the metasurface unitcells, ideally achieving a full 360° phase compensation. Failure to provide sufficient phase-shift compensation leads to phase errors, which can diminish the power enhancement.

The multi-radar near-field sensing system of FIG. 24a, enhanced with a multi-band non-interleaved metasurface, effectively addresses traditional variabilities in human physiology and the diverse ways individuals use wearable devices. By integrating commercial off-the-shelf radar units with on-chip antennas, this system optimizes power absorption and tissue penetration across multiple frequencies, enabling low-cost, high-sensitivity detection of physiological parameters.

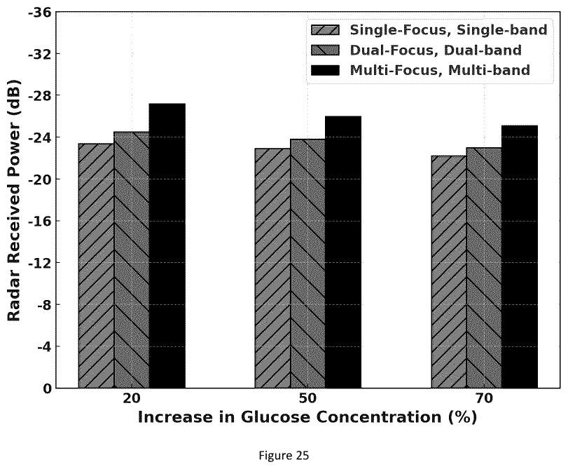

The radar signal-to-noise ratio (SNR) for the system of FIG. 24a was evaluated by analyzing the reflected power from a skin phantom (beaker of pure water) to one of the radar receiver antennas. To demonstrate the effectiveness of near-field sensing with enhanced SNR, varying glucose concentration levels were introduced, altering the permittivity of the skin model. The results, presented in FIG. 25, compare the performance of the single-focus metasurface, dual-band dual-focus metasurface, and multi-band non-interleaved metasurface. The findings indicate that increasing the glucose concentration from 20% to 70% leads to significant variations in SNR. Notably, the dual-focus metasurface consistently outperforms the single-focus design, delivering higher SNR. Furthermore, the multi-band non-interleaved metasurface exhibits superior performance, achieving the highest SNR and improved differentiation between concentration levels. This capability to detect glucose variations across different skin locations, enabled by the multi-sensor averaging approach, highlights the system's enhanced sensitivity and precision, reinforcing its potential for non-invasive health monitoring applications.

Applicants reserve the right to pursue any embodiments or sub-embodiments disclosed in this application; to claim any part, portion, element and/or combination thereof of the disclosed embodiments, including the right to disclaim any part, portion, element and/or combination thereof of the disclosed embodiments; or to replace any part, portion, element and/or combination thereof of the disclosed embodiments.

The above-described embodiments are intended to be examples only. Alterations, modifications and variations can be effected to the particular embodiments by those of skill in the art without departing from the scope, which is defined solely by the claims appended hereto.

What is claimed:

1. A system for enhancing biomedical signal sensing comprising:
at least one radar module for transmitting electromagnetic waves towards a target of interest and for receiving reflected electromagnetic waves; and
at least one metasurface located between the at least one radar module and the target of interest for enhancing at least one of the transmitted electromagnetic waves or the reflected electromagnetic waves.

2. The system of claim 1 wherein the at least one metasurface comprises:
a set of unitcells, each of the set of unitcells having a four-sided footprint including:
a set of electrically conductive end portions adjacent each of the four sides; and
an electrically conductive connector portion connected to each of the set of electrically conductive portions.

3. The system of claim 2 wherein the set of electrically conductive end portions are metallic end portions.

4. The system of claim 2 wherein the electrically conductive connector portion is a metallic, cross-shaped portion.

5. The system of claim 2 wherein each of the unitcells comprises a dielectric substrate on which the set of electrically conductive end portions and the electrically conductive connector portion are applied.

6. The system of claim 5 wherein each of the set of unitcells further comprises:
a second set of electrically conductive end portions adjacent each of the four sides printed on an opposite side of the dielectric substrate; and
a second electrically conductive connector portion connected to each of the second set of electrically conductive end portions printed on the opposite side of the dielectric substrate.

7. The system of claim 2 wherein the set of unitcells are arranged in an N×N array.

8. The system of claim 1 further comprising a processor for processing the received reflected electromagnetic waves.

9. The system of claim 1 wherein the at least one metasurface comprises at least two metasurface layers with frame layers therebetween each adjacent pair of metasurface layers.

10. The system of claim 9 wherein each of the metasurface layers comprises:
a set of metallic unitcells, each of the set of unitcells having a four-sided footprint including:
a set of end slots proximate each of the four sides;
a cross-shaped slot portion connected to each of the set of end slots; and
a set of corner portion slots located in each corner of the unitcell.

10. The system of claim 10 wherein the set of unitcells are arranged in an N×N array.

12. The system of claim 11 wherein a square loop element is formed by adjacent unitcells when in the N×N array.

13. The system of claim 9 wherein the frame layers comprise a dielectric material.

14. The system of claim 1 further comprising at least two metasurfaces, the at least two metasurfaces tuned for operation at different frequencies.

15. The system of claim 14 wherein the at least two metasurfaces are associated with one of the at least one radar modules to form a metasurface-radar module pair to receive reflected electromagnetic waves at the different frequencies.

16. The system of claim 15 further comprising a processor wherein each metasurface-radar module pair is connected to the processor for processing the received reflected electromagnetic waves at the different frequencies.

17. The system of claim 16 further comprising comparing or combining the received reflected electromagnetic waves at different frequencies.
